(19) United States
(12) Patent Application Publication
(10) Pub. No.: US 2026/0187997 A1
(43) Pub. Date: Jul. 2, 2026

(54) INFORMATION PROCESSING SYSTEM, SERVER, INFORMATION PROCESSING METHOD, AND NON-TRANSITORY RECORDING MEDIUM

(71) Applicant: Naoki MOTOHASHI, Kanagawa (JP)

(72) Inventor: Naoki MOTOHASHI, Kanagawa (JP)

(21) Appl. No.: 19/426,093

(22) Filed: Dec. 19, 2025

(30) Foreign Application Priority Data
Dec. 26, 2024 (JP) 2024-230804

(51) Int. Cl. G06V 10/94; G06F 40/10; G06V 10/70; G06V 20/50

(52) U.S. Cl. CPC G06V 10/95; G06F 40/10; G06V 10/70; G06V 20/50

(57) ABSTRACT

An information processing system includes a first server to manage a first image obtained from an image capturing device capturing an image of an object and a second image of the first image, a second server to manage three-dimensional image information of the object, and a terminal device to display, on a screen, the first image received from the first server and the three-dimensional image information received from the second server. The second server associates, based on the second image received from the first server and the three-dimensional image information, the three-dimensional image information with one of the second image and generated information generated based on the three-dimensional image information and the second image. The terminal device displays, on the screen, the three-dimensional image information and the one of the second image and the generated information that are received from the second server in association with each other.

### CROSS-REFERENCE TO RELATED APPLICATIONS

This patent application is based on and claims priority pursuant to 35 U.S.C. § 119(a) to Japanese Patent Application No. 2024-230804, filed on Dec. 26, 2024, in the Japan Patent Office, the entire disclosure of which is hereby incorporated by reference herein.

### BACKGROUND

### Technical Field

The present disclosure relates to an information processing system, a server, an information processing method, and a non-transitory recording medium.

### Related Art

In some cases, a first server and a second server manage pieces of information associated with each other. A terminal device displays information managed by the first server and information managed by the second server.

In a system, such a communication terminal displays information related to a property transmitted from a first management system and a spherical image of the property transmitted from an image management system.

### SUMMARY

The present disclosure described herein provides an information processing system includes a first server to manage a first image obtained from an image capturing device capturing an image of a target object and a second image of the first image. The first server includes first server circuitry. The information processing system includes a second server to manage three-dimensional image information of the target object. The second server includes second server circuitry. The information processing system includes a terminal device to communicate with the first server and the second server. The terminal device includes terminal device circuitry to display, on a display screen, the first image received from the first server and the three-dimensional image information received from the second server. The second server circuitry associates, based on the second image received from the first server and the three-dimensional image information, the three-dimensional image information with one of the second image and generated information. The generated information is generated based on the three-dimensional image information and the second image. The terminal device circuitry displays, on the display screen, the three-dimensional image information and the one of the second image and the generated information in association with each other. The three-dimensional image information and the one of the second image and the generated information are received from the second server.

The present disclosure described herein provides a server including circuitry to associate, based on a second image received from another server and three-dimensional image information of a target object, the three-dimensional image information with one of the second image and generated information. The generated information is generated based on the three-dimensional image information and the second image. The other server manages a first image obtained from an image capturing device capturing an image of the target object and the second image that is an image of a predetermined area in the first image. The circuitry transmits, to a terminal device, the three-dimensional image information and the one of the second image and the generated information. The three-dimensional image information and the one of the second image and the generated information are to be displayed in association with each other on a display screen of the terminal device.

The present disclosure described herein provides an information processing method performed by a server. The method includes associating, based on a second image received from another server and three-dimensional image information of a target object, the three-dimensional image information with one of the second image and generated information. The generated information is generated based on the three-dimensional image information and the second image. The other server manages a first image obtained from an image capturing device capturing an image of the target object and the second image that is an image of a predetermined area in the first image. The method includes transmitting, to a terminal device, the three-dimensional image information and the one of the second image and the generated information. The three-dimensional image information and the one of the second image and the generated information are to be displayed in association with each other on a display screen of the terminal device.

The present disclosure described herein provides a non-transitory recording medium storing a plurality of instructions which, when executed by one or more processors, causes the one or more processors to perform a method. The method includes associating, based on a second image received from another server and three-dimensional image information of a target object, the three-dimensional image information with one of the second image and generated information. The generated information is generated based on the three-dimensional image information and the second image. The other server manages a first image obtained from an image capturing device capturing an image of the target object and the second image that is an image of a predetermined area in the first image. The method includes transmitting, to a terminal device, the three-dimensional image information and the one of the second image and the generated information. The three-dimensional image information and the one of the second image and the generated information are to be displayed in association with each other on a display screen of the terminal device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an information processing system;

FIG. 2 is a block diagram illustrating a hardware configuration of a three-dimensional image management server, a two-dimensional image management server, or a terminal device;

FIG. 3 is a block diagram illustrating functional configurations of a three-dimensional image management server, a two-dimensional image management server, and a terminal device in an information processing system;

FIG. 4 is a conceptual diagram of a three-dimensional image information management table;

FIG. 5 is a conceptual diagram of a two-dimensional image information management table;

FIG. 6 is a sequence diagram illustrating a process of communicating a wide-field image and audio data;

FIGS. 7A and 7B are diagrams illustrating display screens displayed on a terminal device in a model update process and a text information generation process, respectively;

FIGS. 8A and 8B are diagrams illustrating display screens on a terminal device in a model update process and a text information generation process, respectively;

FIG. 9 is a sequence diagram illustrating a process of generating screen information in which a captured image and three-dimensional image information are arranged, as the process based on the captured image and the three-dimensional image information;

FIG. 10 is a diagram illustrating a property specification screen;

FIG. 11 is a diagram illustrating a property management screen;

FIG. 12 is a diagram illustrating a three-dimensional image display screen;

FIG. 13 is a diagram illustrating a captured image display screen;

FIG. 14 is a switching of display of captured images in a second display area;

FIG. 15 is a sequence diagram illustrating a process of generating screen information based on a captured image and three-dimensional image information;

FIGS. 16A and 16B (FIG. 16) are a sequence diagram illustrating a model update process;

FIG. 17 is a diagram illustrating a three-dimensional image display screen displayed on a terminal device;

FIGS. 18A and 18B (FIG. 18) are a sequence diagram illustrating a process of generating text information;

FIG. 19 is a diagram illustrating a three-dimensional image display screen in an inference phase.

FIG. 20 is a diagram illustrating text information displayed on a captured image display screen;

FIG. 21 is a block diagram illustrating functional configurations of a three-dimensional image management server, a two-dimensional image management server, and a terminal device in an information processing system;

FIGS. 22A and 22B (FIG. 22) are a sequence diagram illustrating a process of generating text information and image information; and

FIG. 23 is a diagram illustrating generated image information displayed on a captured image display screen.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system are described below with reference to the drawings.

Supplemental Description of Tacit Knowledge In industries such as civil engineering and construction, the implementation of building information modeling (BIM)/construction information modeling (CIM) has been promoted to address challenges such as a declining birthrate and aging population, as well as enhancing labor productivity.

BIM refers to a solution that utilizes a database of buildings, in which a three-dimensional digital model generated on a computer is supplemented with attribute data, such as cost, finishes, and management information. This solution enables the effective use of information throughout all phases of a building's lifecycle, including design, construction, and subsequent maintenance and management. The three-dimensional digital model may be referred to as a 3D model in the following description.

CIM is a solution that has been proposed for the field of civil engineering (widely covering infrastructure such as roads, electricity, gas, and water supply), following BIM that has been advanced in the field of construction. Similar to BIM, CIM is implemented to enhance and streamline the entire construction production system by information sharing among stakeholders through the use of 3D models as a central platform.

In promoting BIM and CIM, a point is how to utilize the constructed BIM and CIM.

Specifically, the 3D models reconstructed through BIM and CIM can be utilized not only for design and construction purposes, but also for other tasks such as maintenance and management operations and site inspections. In other words, 3D models can be used for other purposes, such as recording information in the models and sharing information with other stakeholders in addition to design drawings.

Since operations performed on the 3D model can be recorded as logs, tacit knowledge extracted from these records may be effectively utilized for purposes such as transferring skills and expertise from experienced personnel to younger or less experienced workers. This is expected to contribute to, for example, front-loading of operations and the development of human resources.

Focusing on the transfer of tacit knowledge, it becomes a challenge not only in the context of 3D models but also when using two-dimensional (2D) data (for example, two-dimensional images such as omnidirectional images, wide-field images, or narrow-field images) effectively convey such tacit knowledge across different tasks and between users with varying levels of expertise.

Specifically, since tacit knowledge is qualitative in nature and difficult to quantify, even if a tacit knowledge model is generated from tacit knowledge, it is challenging to ensure user trust in the tacit knowledge model. As a result, promoting the use of such tacit knowledge models has been difficult. For example, if the domain of expertise of the tacit knowledge model differs from the domain of expertise of the user, then no matter how sophisticated the model may be, the tacit knowledge model holds little to no value for the user. Similarly, if the knowledge level of the tacit knowledge model is lower than the knowledge level of the user, the tacit knowledge model holds little to no value for the user.

However, it is also true that tacit knowledge models can provide users with new perspectives and insights. By utilizing such models, even users with limited experience have the potential to acquire operational expertise and technical capabilities and to apply the acquired operational expertise and technical capabilities effectively in their tasks.

In addition, for a system including a first server that stores property management information, such as a captured image of a property and audio transcript, and a terminal device, there are demands of adding the function of displaying images, such as 3D models, corresponding to the property.

This may be achieved by configuring the first server to acquire the images, such as 3D models of the property. However, adding such a function to the first server will increase the cost.

According to one aspect of the present disclosure, the second server executes a process based on property management information, such as a captured image of a property and an audio transcript, managed by the first server and an image, such as a 3D model of the property, managed by the second server so that the terminal device displays the three-dimensional image information along with the captured image and the audio transcript, which are obtained from the first server, on a single screen in association with each other. The second server causes the terminal device to display tacit knowledge (e.g., text information) about the property generated based on the captured image and the three-dimensional image information in association with the three-dimensional image information, in addition to allowing the terminal device to simply display the two types of information. Accordingly, the terminal device can display the three-dimensional image information and the tacit knowledge about the property on a single screen without a significant functional change of the first server.

### Terms

The term “user” refers to a person who uses text information or non-text content, such as images, generated or output by a tacit knowledge model. The term “data provider” refers to a person who provides data to be used by the tacit knowledge model for learning, such as audio information, character information, operation information, images, and 3D data.

The term “tacit knowledge” refers to knowledge based on, for example, personal experience and intuition. The term “tacit knowledge model” refers to a model that learns tacit knowledge and outputs responses to questions based on the learned tacit knowledge. The term “model” refers to a mechanism or artificial intelligence (AI) that learns the correspondence between input data and output data, and outputs data in response to the input data. The output data is generated regardless of the presence of training data.

The term “property” refers to any space in which an item can be placed, such as a facility or a room in a facility. The term “item” refers to an item that is placed in a property. The type of item to be placed varies depending on the function of the facility.

Examples of such properties include, but are not limited to, real estate, industrial plants, construction sites, research institutions, healthcare facilities, agricultural land, storage facilities, and other infrastructure requiring maintenance and management. Examples of such items include, but are not limited to, furniture, construction materials, equipment, heavy machinery, tools, instruments, raw materials, biological cultures, and food products.

The term “target object” refers to an object to be captured by an image capturing device to manage the state of the object by, for example, recording the images. In the following description, the target object is referred to as an item. For example, the target object is an item placed in a property.

The term “three-dimensional image information of an item” refers to an image obtained by capturing a 3D model by a virtual camera. The three-dimensional image information allows users to change the viewpoint.

The term “generated information” refers to information generated based on three-dimensional image information and a captured image. The generated information may be generated by a tacit knowledge model. In the following description, the generated information is referred to as a tacit knowledge-based comment or text information.

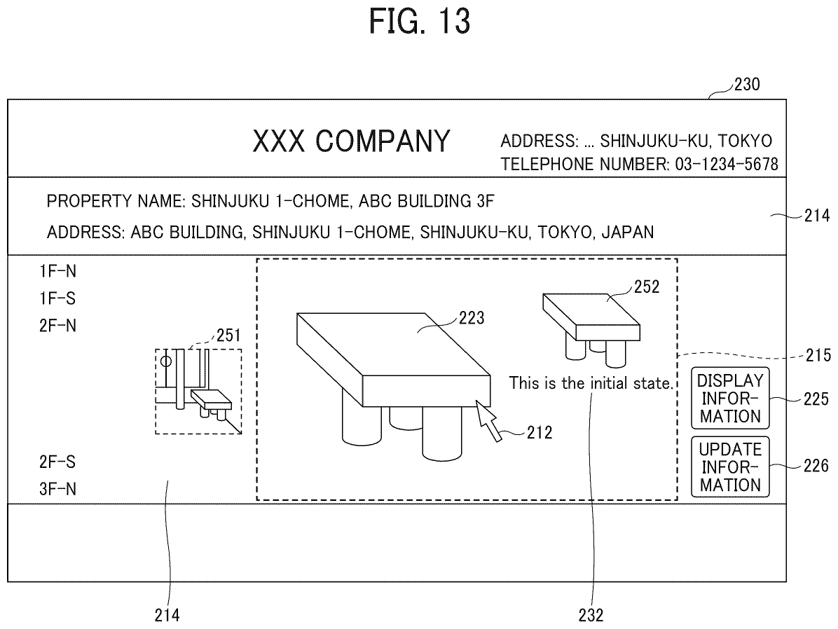

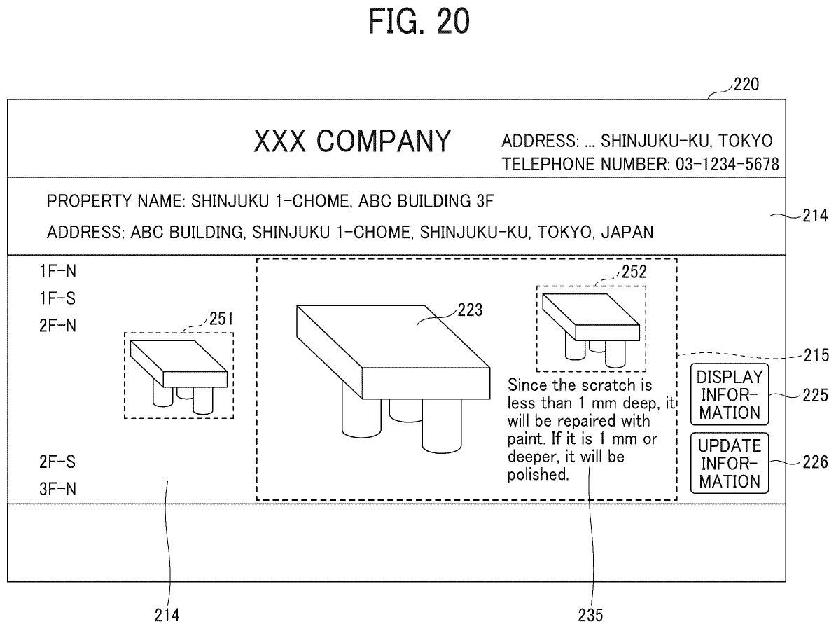

The term “display screen” refers to a single screen on which three-dimensional image information is displayed together with a captured image or generated information. FIGS. 13 and 20 each illustrate a display screen.

The term “wide-field image” refers to an image with a capture range that extends beyond the standard field of view. For example, the wide-field image that is an example of a “first image” is captured over a wide capture range with a wide field of view and may include, for instance, a 360-degree image that captures the entire surroundings.

The 360-degree image may be also referred to as a spherical image, an omnidirectional image, or an all-round image.

The term “predetermined-area image” refers to an image corresponding to a predetermined area that is a part of a wide-field image. The predetermined-area image that is an example of a “second image” is projected on a two-dimensional plane and is a planar image. In the following description, the predetermined-area image stored by a capture operation is referred to as a “captured image”.

### First Embodiment

### System Configuration

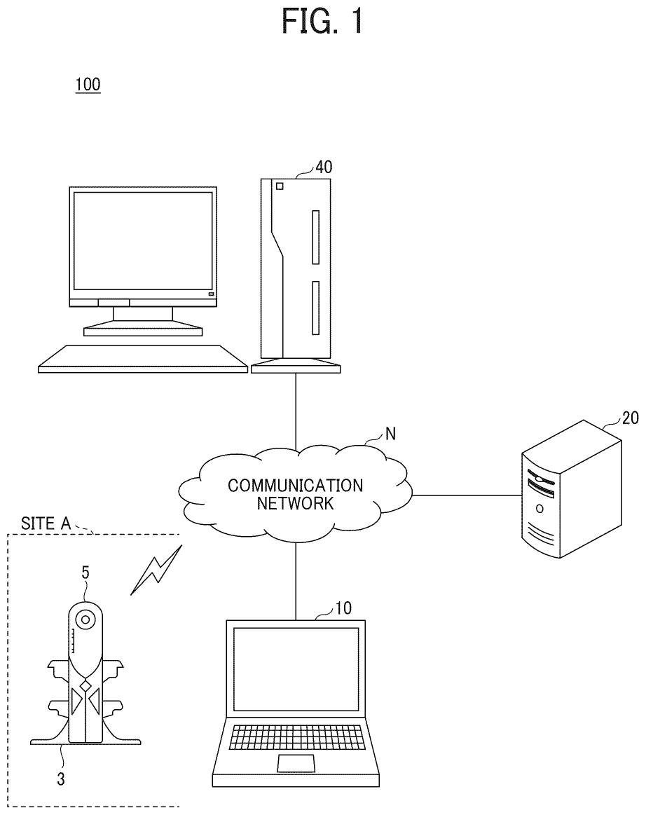

FIG. 1 is a schematic diagram of an information processing system 100. The information processing system 100 includes a terminal device 10, an image capturing device 5, a three-dimensional image management server 40, and a captured image management server 20. The terminal device is an example of an input and output device. The terminal device 10 is not necessarily included in the information processing system 100 and may be connected to the three-dimensional image management server 40 or the captured image management server 20 as needed.

The three-dimensional image management server 40, which is an example of a second server, is one or more information processing apparatuses that communicate with the terminal device 10 via a communication network N. The three-dimensional image management server 40 manages three-dimensional image information of properties and has a tacit knowledge model and a large-scale language model. The three-dimensional image management server 40 uses these resources to return text information including tacit knowledge to the user. The three-dimensional image management server 40 may be a web server that returns a processing result to the terminal device 10 in response to a request from the terminal device 10. The server is a computer or software that functions to provide information or a processing result in response to a request from a client.

The three-dimensional image management server 40 may support cloud computing. The term “cloud computing” refers to a model of computing in which resources on a network are used without being aware of specific hardware resources. Cloud computing may take any of various forms including Software as a Service (SaaS), Platform as a Service (PaaS), and Infrastructure as a Service (IaaS). For this reason, the three-dimensional image management server 40 does not need to be housed in a single housing or implemented by a single apparatus. The functions of the three-dimensional image management server 40 may be allocated among multiple information processing apparatuses. Alternatively, each of the multiple information processing apparatuses may have all the functions, with processing being switched among the information processing apparatuses based on load balancing or similar mechanisms. The three-dimensional image management server 40 may be a server residing in an on-premises environment.

Instead of the three-dimensional image management server 40 having the tacit knowledge model and the large-scale language model, the three-dimensional image management server 40 may call an application programming interface (API) published by an external system and use at least one of the tacit knowledge model and the large-scale language model.

The captured image management server 20, which is an example of a first server, is one or more information processing apparatuses that communicate with the terminal device 10 via the communication network N. The captured image management server 20 manages property management information. The property management information is string data presented as a text string, such as text information. The captured image management server 20 does not have three-dimensional image information. The captured image management server 20 can stream live images of the wide-field image captured by the image capturing device 5. The captured image management server 20 manages captured images captured by users. The captured image management server 20 is a server that allows users to manage construction progress and item arrangement while viewing video data of the property.

The captured image management server 20 may be a web server that returns a processing result to the terminal device 10 in response to a request from the terminal device 10. The captured image management server 20 communicates with the three-dimensional image management server 40 via the communication network N. The captured image management server 20 may support either cloud computing or on-premises environments.

Preferably, the three-dimensional image management server 40 and the captured image management server 20 are integrated enough to support single sign-on. The three-dimensional image management server 40 communicates with the captured image management server 20 via an API exposed by the captured image management server 20. Alternatively, the three-dimensional image management server 40 and the captured image management server 20 may be integrated or linked for operational purposes.

The terminal device 10 is a general-purpose information processing terminal used by a user of the information processing system 100. On the terminal device 10, a web browser and a native application dedicated to the three-dimensional image management server 40 or the captured image management server 20 operate. In a case where the terminal device 10 executes a web browser, the terminal device 10 and the three-dimensional image management server 40 or the captured image management server 20 execute a web application. Specifically, the web application is an application that operates through the cooperation of a program written in a programming language (e.g., JAVASCRIPT) running on a web browser and a program running on a web server (e.g., the three-dimensional image management server 40).

When the web application is executed, processing may be performed by the three-dimensional image management server 40 or the captured image management server 20, or by the terminal device 10 that has received the web application.

An application that is not executed unless installed in the terminal device 10 is referred to as a native application. The application executed by the terminal device 10 may be a web application or a native application. In this case, processing may be performed by the three-dimensional image management server 40 or the terminal device 10 that executes the native application.

The terminal device 10 is, for example, a personal computer (PC), a smartphone, a personal digital assistant (PDA), or a tablet terminal. The terminal device 10 may be any other device on which a web browser or a native application operates. The terminal device 10 may be an electronic whiteboard, a television receiver, a smart glass device, or a wearable device. Multiple terminal devices 10 may be present.

The terminal device 10 communicates with three-dimensional image management server 40 and the captured image management server 20 via the communication network N. The communication network N is implemented by, for example, the Internet, a local area network (LAN), or a provider service.

The communication network N may include not only wired communication but also mobile communication networks in compliance with, for example, 3rd Generation Mobile Communication System (3G), Worldwide Interoperability for Microwave Access (WiMAX), or Long-Term Evolution (LTE), and networks using wireless LANs. The terminal device 10 can establish communication by a short-range communication technology, such as BLUETOOTH or near field communication (NFC).

The image capturing device 5 is a digital camera to acquire wide-field images or record audio.

The image capturing device 5 connects to the communication network N via the relay device 3. The relay device 3 has a cradle function for charging the image capturing device 5 and transmitting and receiving data to and from the image capturing device 5. The relay device 3 can communicate with the image capturing device 5 via a contact point and can communicate with the captured image management server 20 via the communication network N. The image capturing device 5 and the relay device 3 are installed at predetermined positions on a site Sa such as a construction site, exhibition venue, educational institution, or medical facility. The image capturing device 5 may also be a digital camera that obtains regular narrow-field images, such as a single-lens reflex camera. The captured image management server 20 may also stream live images of a narrow-field image captured by the image capturing device 5. In this case, the predetermined-area image is an image corresponding to all or part of a predetermined area of the wide-field image or the narrow-field image.

In FIG. 1, the three-dimensional image management server 40, the captured image management server 20, and the terminal device 10 communicate with each other via the communication network N. However, the user may directly operate the three-dimensional image management server 40 or the captured image management server 20 from the control panel.

### Hardware Configuration

### Three-Dimensional Image Management Server, Captured Image Management Server, Terminal Device

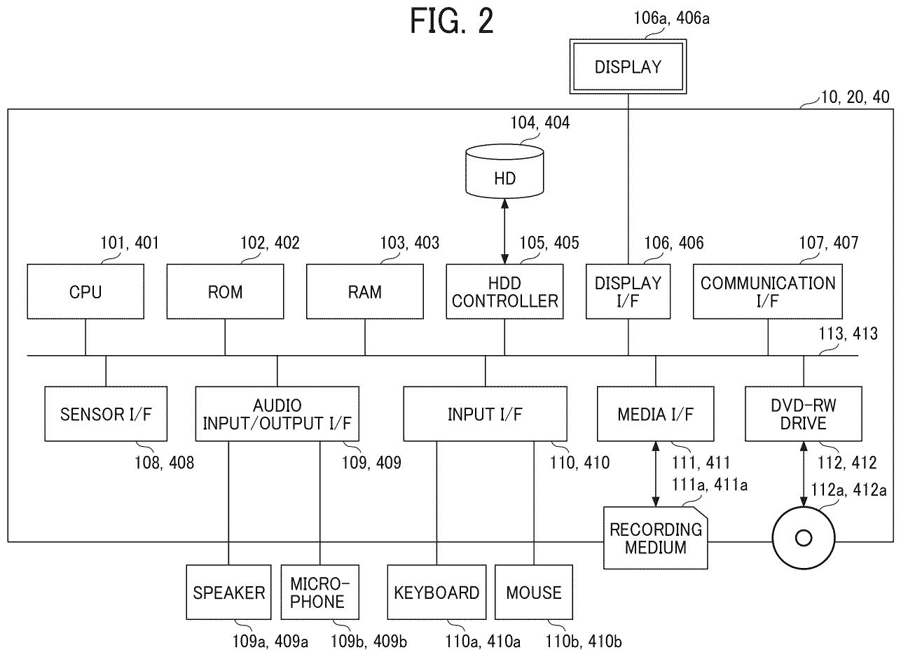

FIG. 2 is a block diagram illustrating a hardware configuration applicable to each of the three-dimensional image management server 40, the captured image management server 20, and the terminal device 10. Each hardware component of the three-dimensional image management server 40 or the captured image management server 20 is denoted by a reference numeral in the 400s. Each hardware component of the terminal device 10 is denoted by a reference numeral in the 100s.

The hardware configuration of the terminal device 10 is described below. Since the hardware configuration of the three-dimensional image management server 40 or the captured image management server 20 is substantially the same as that of the terminal device 10, the description thereof will be omitted.

The terminal device 10 is implemented by a computer. As illustrated in FIG. 2, the terminal device 10 includes a central processing unit (CPU) 101, a read-only memory (ROM) 102, a random-access memory (RAM) 103, a hard disk (HD) 104, a hard disk drive (HDD) controller 105, a display interface (I/F) 106, and a communication I/F 107.

The CPU 101 controls the overall operation of the terminal device 10. The ROM 102 stores a program such as an initial program loader (IPL) used for booting the CPU 101. The RAM 103 is used as a work area for the CPU 101.

The HD 104 stores various data such as a control program. The HDD controller 105 controls the reading or writing of various data from or to the HD 104 under the control of the CPU 101.

The display I/F 106 is a circuit to control a display 106a to display an image.

The display 106a is an example of a display unit, such as a liquid crystal display or an organic electroluminescence (EL) display that displays various types of information, such as the cursor, menus, windows, text, or images. The communication I/F 107 is an interface used for communication with another device (external device).

When the terminal device 10 is a glass device, the terminal device 10 may use a circuit that causes a lens as a transmissive reflective member to display an image in an alternative to the display I/F 106.

The communication I/F 107 is, for example, a network interface card (NIC) in compliance with transmission control protocol/internet protocol (TCP/IP).

The terminal device 10 further includes a sensor I/F 108, an audio input/output I/F 109, an input I/F 110, a media I/F 111, and a digital versatile disk rewritable (DVD-RW) drive 112.

The sensor I/F 108 is an interface that receives information detected by various sensors. The audio input/output I/F 109 is a circuit that processes the input of audio signals from a microphone 109b and the output of audio signals to a speaker 109a under the control of the CPU 101. The input I/F 110 is an interface for connecting an input device to the terminal device 10.

A keyboard 110a is a type of input device equipped with multiple keys used for entering, for example, characters, numbers, and various commands. A mouse 110b is a type of input device that enables, for example, the selection and execution of various commands, the selection of processing targets, the movement of the cursor, or operations on a display screen.

The media I/F 111 controls the reading or writing (storage) of data to or from a recording medium 111a, such as flash memory. The DVD-RW drive 112 controls the reading or writing of various data to or from a DVD-RW 112a, which is an example of a removable recording medium. The removable recording medium is not limited to the DVD-RW. For example, the removable recording medium may be a DVD-recordable (DVD-R). Further, the DVD-RW drive 112 may be a BLU-RAY drive to control the reading or writing of various data to or from a BLU-RAY disc.

The terminal device 10 further includes a bus line 113. The bus line 113 includes an address bus and a data bus and electrically connects components such as the CPU 101 to each other.

Recording media, such as HDs or compact disc read-only memories (CD-ROMs) on which the above-mentioned programs are stored, may be provided as program products, either domestically or internationally. The terminal device 10 implements an information processing method by, for example, executing a program.

### Functions

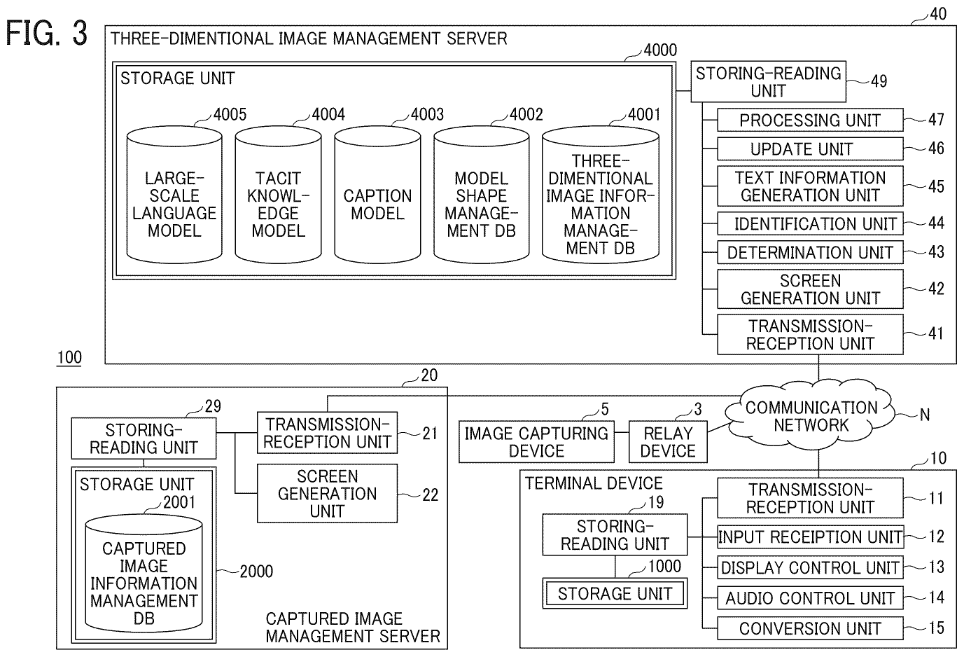

FIG. 3 is a block diagram illustrating functional configurations of the three-dimensional image management server 40, the captured image management server 20, and the terminal device 10 in the information processing system 100. Each of the image capturing device 5 and the relay device 3 is assumed to have functions already known.

### Terminal Device

As illustrated in FIG. 3, the terminal device 10 includes a transmission-reception unit 11, an input reception unit 12, a display control unit 13, an audio control unit 14, a conversion unit 15, and a storing-reading unit 19. These functional units are functions or means of functioning that are implemented by the operation of one or more hardware components illustrated in FIG. 2 in response to instructions from the CPU 101, based on a program loaded from the HD 104 to the RAM 103. The terminal device 10 further includes a storage unit 1000, which is implemented by at least one of the RAM 103 and the HD 104 illustrated in FIG. 2.

The transmission-reception unit 11 is an example of a transmission unit or a reception unit and implemented by instructions from the CPU 101 illustrated in FIG. 2, as well as the communication I/F 107 illustrated in FIG. 2. The transmission-reception unit 11 transmits and receives various data (or information) to and from another terminal, device, apparatus, or system via the communication network N.

The input reception unit 12, which is an example of an input reception unit, is implemented by instructions from the CPU 101 illustrated in FIG. 2, as well as by the input I/F 110 and the audio input/output I/F 109 illustrated in FIG. 2. The input reception unit 12 receives various inputs from the user via the microphone 109b, the keyboard 110a, or the mouse 110b illustrated in FIG. 2.

The display control unit 13, which is an example of a display control unit and an output unit, is implemented by instructions from the CPU 101 illustrated in FIG. 2 and the display I/F 106 illustrated in FIG. 2. The display control unit 13 causes the display 106a, which is an example of a display unit, to display various images and screens. When the terminal device 10 is a glass device, the display control unit 13 causes virtual images to be displayed on a transmissive and reflective member, such as a lens, in place of the display I/F 106.

The audio control unit 14, which is an example of an audio control unit and an output unit, is implemented by instructions from the CPU 101 illustrated in FIG. 2 and the audio input/output I/F 109 illustrated in FIG. 2. The audio control unit 14 causes sound to be reproduced through the speaker 109a, which is an example of an audio reproduction unit.

The conversion unit 15, which is an example of a processing unit, is implemented by instructions from the CPU 101 illustrated in FIG. 2. The conversion unit 15 performs processing for converting character information into audio information, and processing for converting audio information into character information.

The storing-reading unit 19 is an example of a storing control unit and implemented by instructions from the CPU 101 illustrated in FIG. 2, as well as the HD 104, the media I/F 111, and the DVD-RW drive 112 illustrated in FIG. 2. The storing-reading unit 19 stores various data or retrieves various data in or from the storage unit 1000, the recording medium 111a, and the DVD-RW 112a.

### Functional Configuration of Three-Dimensional Image Management Server

The three-dimensional image management server 40 includes a transmission-reception unit 41, a screen generation unit 42, a determination unit 43, an identification unit 44, a text information generation unit 45, an update unit 46, a processing unit 47, and a storing-reading unit 49. These functional units are functions or means of functioning that are implemented by the operation of one or more hardware components illustrated in FIG. 2 in response to instructions from the CPU 401, based on a program loaded from the HD 404 to the RAM 403. The three-dimensional image management server 40 further includes a storage unit 4000, which is implemented by the HD 404 in FIG. 2. The storage unit 4000 is an example of a memory (storage means).

In FIG. 3, all the functions are implemented on the single three-dimensional image management server 40. Alternatively, the three-dimensional image management server 40 may be configured such that the functions are distributed across multiple computers.

The transmission-reception unit 41 is an example of a transmission unit or a reception unit and is implemented by instructions from the CPU 401 illustrated in FIG. 2 as well as the communication I/F 407 illustrated in FIG. 2. The transmission-reception unit 41 transmits and receives various data (or information) to and from another terminal, device, apparatus, or system via the communication network N.

The screen generation unit 42, which is an example of a screen generation unit, is implemented by instructions from the CPU 401 illustrated in FIG. 2. The screen generation unit 42 generates various screens. In a case where the terminal device 10 executes a web application, the screen information is generated in a format of, for example, HyperText Markup Language (HTML), eXtensible Markup Language (XML), Cascading Style Sheets (CSS), or JAVASCRIPT. For this reason, the screen information may be referred to as a web application. In a case where the terminal device 10 executes a client application, the screen information is held by the terminal device 10, and the screen information representing the screen to be displayed is transmitted in a format of, for example, XML.

The determination unit 43, which is an example of a determination unit, is implemented by instructions from the CPU 401 illustrated in FIG. 2. The determination unit 43 performs various determinations described later.

The identification unit 44, which is an example of an identification unit, is implemented by instructions from the CPU 401 illustrated in FIG. 2. The identification unit 44 identifies a target image.

The text information generation unit 45, which is an example of a text information generation unit, is implemented by instructions from the CPU 401 illustrated in FIG. 2. The text information generation unit 45 acquires tacit knowledge-based comments from a tacit knowledge model or generates text information based on a large-scale language model 4005.

The update unit 46, which is an example of an update unit, is implemented by instructions from the CPU 401 illustrated in FIG. 2. The update unit 46 updates a tacit knowledge model described later.

The processing unit 47 performs association processing, based on three-dimensional image information and a captured image, for associating the three-dimensional image information with the captured image, or for associating the three-dimensional image information with generated information (text information) that is generated based on the three-dimensional image information and the captured image, in accordance with processing requested by the user.

The processing performed by the processing unit 47 includes displaying, on a single screen, the two types of information associated with each other or obtaining a tacit knowledge-based comment from the tacit knowledge model 4004, by using the captured image and the three-dimensional image information. The tacit knowledge-based comment is an example of text information. The processing unit 47 requests, for example, the screen generation unit 42 or the text information generation unit 45 to perform the processing in accordance with the content of the processing.

The storing-reading unit 49 is an example of the storing control unit and is implemented by instructions from the CPU 401 illustrated in FIG. 2, as well as the HD 404, a media I/F 411, and a DVD-RW drive 412 illustrated in FIG. 2. The storing-reading unit 49 stores various data in or retrieves various data from the storage unit 4000, a recording medium 411a, or a DVD-RW 412a. The storage unit 4000, the recording medium 411a, and the DVD-RW 412a are examples of storage units.

In the storage unit 4000, a three-dimensional image information management database (DB) 4001, a model shape management DB 4002, a caption model 4003, a tacit knowledge model 4004, and a large-scale language model 4005 are built.

The three-dimensional image information management DB 4001 manages three-dimensional image information of an item placed in a property. The three-dimensional image information is information that visually represents an item (also referred to as a model) placed in a property. The model shape management DB 4002 manages three-dimensional model shape information of an item placed in a property. The three-dimensional image management server 40 generates three-dimensional image information on a property based on three-dimensional model shape information. The three-dimensional model shape information is information for drawing an item in three dimensions, such as a three-dimensional model of the item or a three-dimensional point cloud of the item. The three-dimensional model shape information may be represented by data formats such as polygonal data or Computer-Aided Design (CAD) data. The three-dimensional image information management DB 4001 or the model shape management DB 4002 may store a wide-field image, such as a spherical image of a property.

The caption model 4003 is generated by executing a learning process using a combination of an image and a caption comment as learning data and causes a computer to output a caption comment based on the image. The caption comments are explicit knowledge and used as expressions representing tacit knowledge. The caption comment is represented by text data and is a comment for explaining an image among audio or text comments. A caption comment on a property or an item is associated with the identification information of the property or the item.

The tacit knowledge model 4004 is generated by executing a learning process using, as learning data, the correspondence between a combination of three-dimensional image information and a captured image and tacit knowledge (e.g., input information, audio transcript) related to the combination of the three-dimensional image information and the captured image. The tacit knowledge model 4004 causes a computer to output a tacit knowledge-based comment based on an image. The tacit knowledge model 4004 learns on the correspondences between:
the combination of three-dimensional image information and a captured image, and input information;—the combination of three-dimensional image information and a captured image, and an audio transcript; and—the combination of three-dimensional image information and a captured image, and the combination of an audio transcript and input information. The tacit knowledge-based comment is represented by text data and is a comment other than a caption comment among audio or text comments. In other words, the tacit knowledge-based comment is a comment relating to content that has not appeared in the image.

The large-scale language model 4005 is a computer language model that is generated by executing a learning process using a huge amount of unlabeled text as learning data and is developed on an artificial neural network having a large number of parameters. Sufficient training through methods for learning contexts, such as next sentence prediction and masked language modeling, enables the large-scale language model 4005 to capture many of syntax and meanings of human words. In next sentence prediction, the context is understood, for example, by determining whether a first sentence and a second sentence are consecutive. In masked language modeling, the context is understood by masking a word in a sentence and predicting the masked word from the words preceding and subsequent thereto.

### Three-Dimensional Image Information Management Table

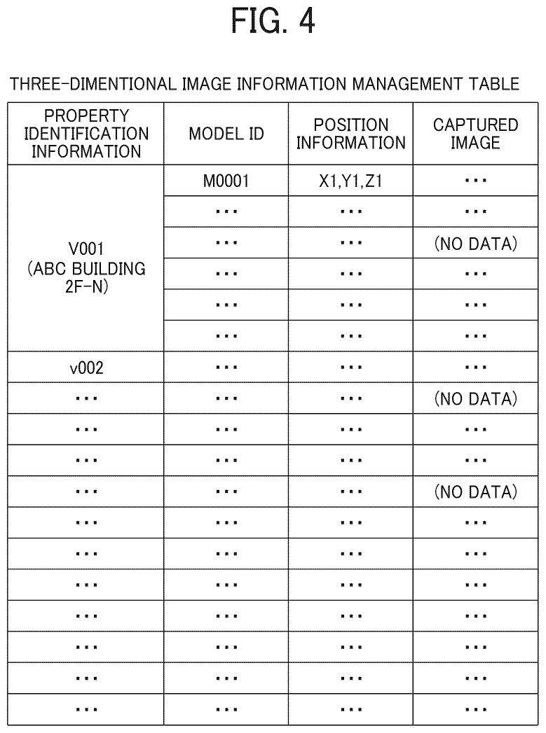

FIG. 4 is a conceptual diagram of a three-dimensional image information management table. The storage unit 4000 stores the three-dimensional image information management DB 4001 that is implemented in the form of an image information management table as illustrated in FIG. 4. In the three-dimensional image information management table in FIG. 4, model identification information, position information, a captured image are stored in association with property identification information.

The property identification information is an example of information for identifying a property. The term “property” refers to any space in which an item can be placed, such as a facility or a room in a facility. The types of items placed within a facility vary depending on the function of the facility. The property may be represented in units that are easy to manage, such as “ABC building 2F-N (north side of the second floor)”.

The model ID is an example of identification information for identifying an item placed in a property. The item may be represented as three-dimensional model shape information such as polygonal data or computer-aided design (CAD) data, stored in the model shape management DB 4002. The three-dimensional image information is associated with a three-dimensional model shape stored in the model shape management DB 4002 by the model ID.

The position information is information indicating the position of the model of an item in a three-dimensional virtual space representing a property, by three-dimensional coordinates of XYZ. The position information is indicated by, for example, the three-dimensional coordinates of eight points defining a rectangular parallelepiped space occupied by the model.

This position information is obtained as the positional information (latitude, longitude, and altitude) of the relay device 3, by a global navigation satellite system (GNSS) satellite such as a global positioning system (GPS) satellite or using an indoor MEssaging system (IMES) as an indoor GPS. Indoor positioning may be performed using various methods, such as Wi-Fi positioning, radio frequency identifier (RFID) positioning, beacon-based positioning, pedestrian dead reckoning, geomagnetic positioning, acoustic positioning, and ultra wide band (UWB) positioning.

The captured image is a two-dimensional image obtained from the captured image management server 20. The term “capture” refers to acquiring a still image at a specific moment. The captured image is an image that is obtained by extracting a predetermined area, specified by the field of view, from a wide-field image captured by the image capturing device 5. The reason a captured image is registered in association with an item is that the three-dimensional image information is represented by a 3D model. When the user selects an item within the three-dimensional image information, the item (model ID) is identified based on its coordinates. Alternatively, the three-dimensional image management server 40 may determine the position and field of view of the virtual camera based on the position information and the field of view information of the image capturing device 5 in a live image and may identify the model of the item that enters the field of view from this position. The three-dimensional image management server 40 associates the captured image with the model ID of the identified item. Accordingly, the captured image may include items.

The position information in FIG. 4 is stored in association with the absolute position on the earth. For example, by associating the origin (X=0, Y=0, Z=0) of the position information in FIG. 4 with the absolute position (latitudes, longitudes, altitudes) on the earth, all coordinates in the three-dimensional image including the three-dimensional model and items, are associated with the absolute position on the earth.

### Functional Configuration of Captured Image Management Server

Referring back to FIG. 3, the functional configuration of the captured image management server 20 is described below. The captured image management server 20 includes a transmission-reception unit 21, a screen generation unit 22, and a storing-reading unit 29. These functional units are functions or means of functioning that are implemented by the operation of one or more hardware components illustrated in FIG. 2 in response to instructions from the CPU 401, based on a program loaded from the HD 404 to the RAM 403. The captured image management server 20 further includes a storage unit 2000 implemented by the HD 404 in FIG. 2. The storage unit 2000 is an example of a storage unit.

In FIG. 3, all the functions are implemented on the single captured image management server 20. Alternatively, the captured image management server 20 may be configured such that the functions are distributed across multiple computers.

The transmission-reception unit 21, which is an example of a transmission unit or a reception unit, is implemented by instructions from the CPU 401 illustrated in FIG. 2 and the communication I/F 407 illustrated in FIG. 2. The transmission-reception unit 41 transmits and receives various data (or information) to and from another terminal, device, apparatus, or system via the communication network N.

The screen generation unit 22, which is an example of a screen generation unit, is implemented by instructions from the CPU 401 illustrated in FIG. 2. The screen generation unit 42 generates various screens. In a case where the terminal device 10 executes a web application, the screen information is generated in a format of, for example, HTML, XML, CSS, or JAVASCRIPT. For this reason, the screen information may be referred to as a web application. In a case where the terminal device 10 executes a client application, the screen information is held by the terminal device 10, and the screen information representing the screen to be displayed is transmitted in a format of, for example, XML.

The storing-reading unit 29, which is an example of a memory control unit, is implemented by instructions from the CPU 401 illustrated in FIG. 2, as well as by the HD 404, the media I/F 411, and the DVD-RW drive 412 illustrated in FIG. 2. The storing-reading unit 49 performs processing to store various data in, or retrieve various data from, the storage unit 2000, the recording medium 411a, and the DVD-RW 412a. The storage unit 2000, the recording medium 411a, and the DVD-RW 412a are examples of storage units.

### Captured Image Information Management Table

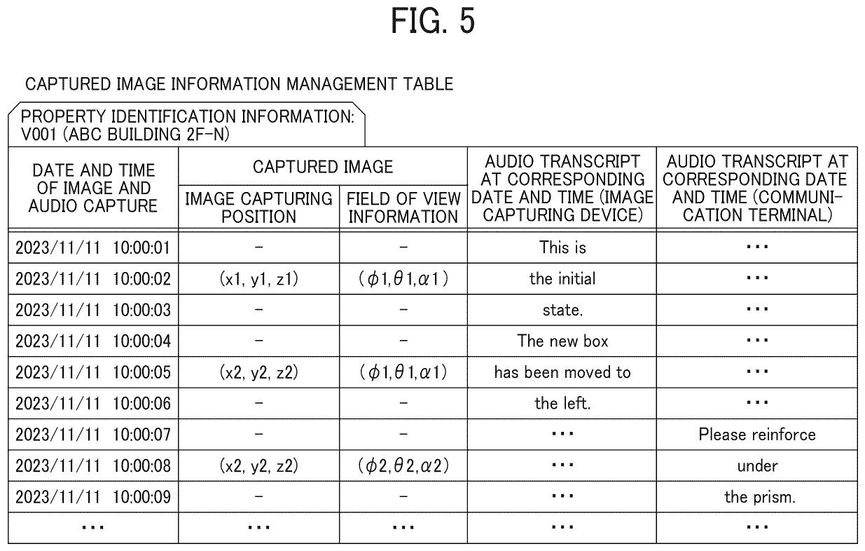

FIG. 5 is a conceptual diagram of a captured image information management table. The storage unit 2000 stores the captured image information management DB 2001 that is implemented in the form of a captured image information management table as illustrated in FIG. 5.

In the captured image information management table, a live image and a captured image are stored in association with property identification information. In the captured image information management table, the date and time of “image and audio capture”, the image capturing position, the field of view information, the audio transcript at the corresponding date and time (image capturing device), and the audio transcript at the corresponding date and time (communication terminal) are stored in association with property identification information as data items to be managed. The position of the image capturing device 5 is determined by the relay device 3 to which the image capturing device 5 is attached. The position of the image capturing device 5 may be determined by the image capturing device itself.

The date and time of “image and audio capture” indicates the moment when the image capturing device 5 records the live image and collects the audio. In FIG. 5, live images are captured at one-second intervals, but capturing at 30 fps or other frame rates is also acceptable.

The image capturing position indicates the position (absolute position on the earth) of the image capturing device 5 at the time the wide-field image was captured. As described later, the terminal used to view live images during meetings is called a communication terminal, and the operation that allows the user of the communication terminal to save a captured image of the desired field of view from the wide-field image is called the capture operation. The image stored by a capture operation is a captured image via capture operation. This captured image is transmitted to the three-dimensional image management server 40. Further, the image capturing position is also an audio collection (capturing) position. The field of view information is used to identify the predetermined area of the wide-field image that is being displayed on the communication terminal when the user performs the capture operation.

The audio transcript registered in the “audio transcript at the corresponding date and time (image capturing device)” field is text data converted from the audio (voice) collected by the image capturing device 5 through voice recognition. The audio transcript is comment data regarding an item that a participant of the meeting spoke about while viewing a live image.

The audio transcript registered in the “audio transcript at the corresponding date and time (communication terminal)” field is text data converted from the speech uttered by participants viewing live images on the communication terminal through voice recognition. The audio transcript is comment data regarding an item that a participant of the meeting spoke about while viewing a live image.

### Transmitting Content Data

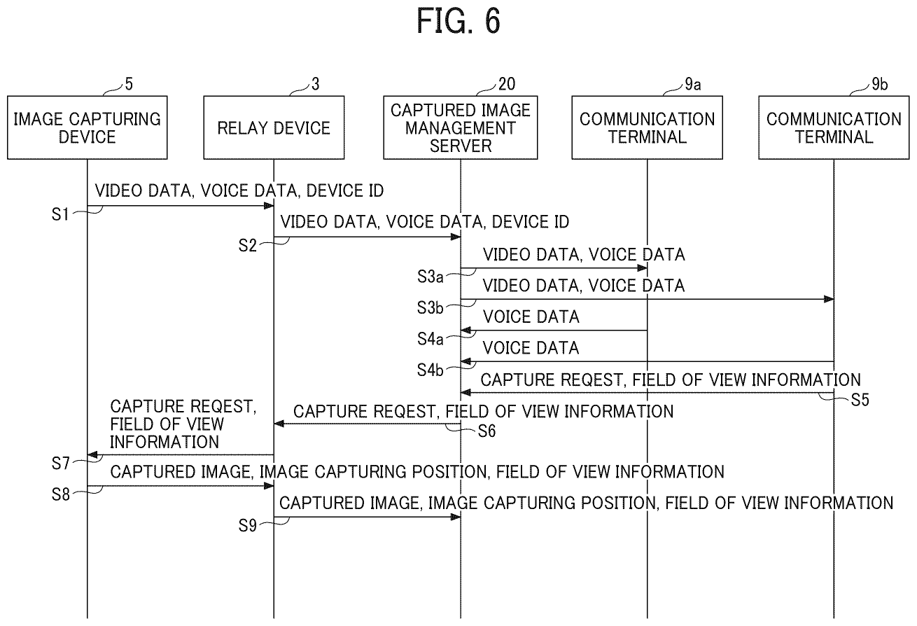

FIG. 6 is a sequence diagram illustrating a process of communicating a wide-field image and audio data. In the following description, the image capturing device 5, a communication terminal 9a used by a participant A, and a communication terminal 9b used by a participant B are participating in the same remote communication. Steps S1 through S4 in FIG. 6 are performed repeatedly.

In step S1, the image capturing device 5 captures an image of the surroundings and collects audio to transmit video data (wide-field image) and audio data to the relay device 3. The image capturing device 5 also transmits a device ID for identifying the image capturing device 5 to specify the property. As a result, the relay device 3 acquires the video data and the audio data. The captured image management server 20 has device IDs pre-associated with properties.

In step S2, the relay device 3 transmits the acquired video data, audio data, and device ID to the captured image management server 20 via the communication network N. Accordingly, the transmission-reception unit 21 of the captured image management server 20 receives the video data, audio data, and device ID.

The captured image management server 20 identifies a property by the device ID. As a result, the live images and the date and time of image and audio capture are stored by the storing-reading unit 29 in the captured image information management DB 2001, for example, every second. The live images may be streamed without being stored.

The captured image management server 20 (or an existing voice recognition server) generates text data (also referred to as audio transcript) by converting the voice part into text using the audio data. The storing-reading unit 29 stores the audio transcript in the captured image information management DB 2001.

In step S3a, the captured image management server 20 reads participant IDs that are participating in the same meeting as the image capturing device 5 from, for example, the meeting information. The captured image management server 20 further reads the IP addresses of the communication terminals 9a and 9b based on the read participant IDs. The captured image management server 20 refers to the IP address of the communication terminal 9a and transmits the received video data and audio data to the communication terminal 9a. As a result, the communication terminal 9a receives the video data and the audio data, displays the wide-field image, and outputs the sound.

In step S3b, in a similar manner, the captured image management server 20 refers to the IP address of the communication terminal 9b and transmits the video data and the audio data to the communication terminal 9b. As a result, the communication terminal 9b displays the wide-field image and outputs the sound.

In steps S4a and 4b, the communication terminals 9a and 9b transmit the voice data of participants A and B to the captured image management server 20. This audio data is generated by the microphone capturing the voice of participants A and B operating communication terminals 9a and 9b, respectively, and converting the voice into audio data. The storing-reading unit 29 of the captured image management server 20 stores the audio transcript in the captured image information management DB 2001.

In step S5, each of the participants A and B of the communication terminals 9a and 9b (participant B in FIG. 6) can change the viewpoint of the video data, which is a wide-field image. When the participant B wants to save a predetermined-area image of the wide-field image displayed by changing the viewpoint, the participant B can perform the capture operation at any desired timing.

When the capture operation is accepted, the communication terminal 9b transmits a capture request and the field of view information indicating the predetermined area currently displayed on the display to the captured image management server 20.

In step S6, upon receiving the capture request and field of view information, the captured image management server 20 identifies the IP address of the relay device 3 participating in the same meeting as the communication terminal 9b and transmits the capture request and field of view information.

In step S7, the relay device 3 receives the capture request and field of view information and transfers the capture request and field of view information to the image capturing device 5.

In step S8, upon receiving the capture request, the image capturing device 5 generates a captured image based on the field of view information. The image capturing device 5 transmits the captured image, image capturing position, and field of view information to the relay device 3.

In step S9, the relay device 3 transmits the captured image, image capturing position, and field of view information to the captured image management server 20. The captured image management server 20 identifies a property by the device ID, similar to step S3. The storing-reading unit 29 stores the captured image, image capturing position, and field of view information in the captured image information management DB 2001.

As a result of the above processing, the captured image information management DB 2001 stores wide-field images (live images) and audio data in real-time, and when a participant performs a capture operation, the captured image, image capturing position, and field of view information are also stored.

In FIG. 6, the image capturing device 5 generates a captured image in response to the request from the communication terminal 9b, but the communication terminal 9b may also generate a captured image of the predetermined area currently displayed and transmit the captured image to the captured image management server 20.

### Example of Update of Model and Generation of Text Information

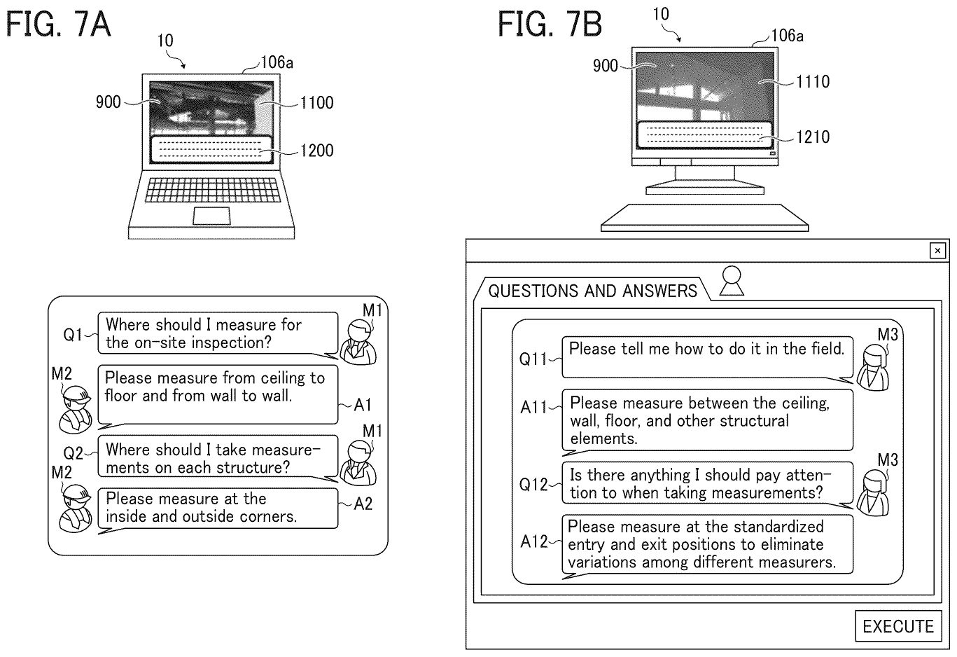

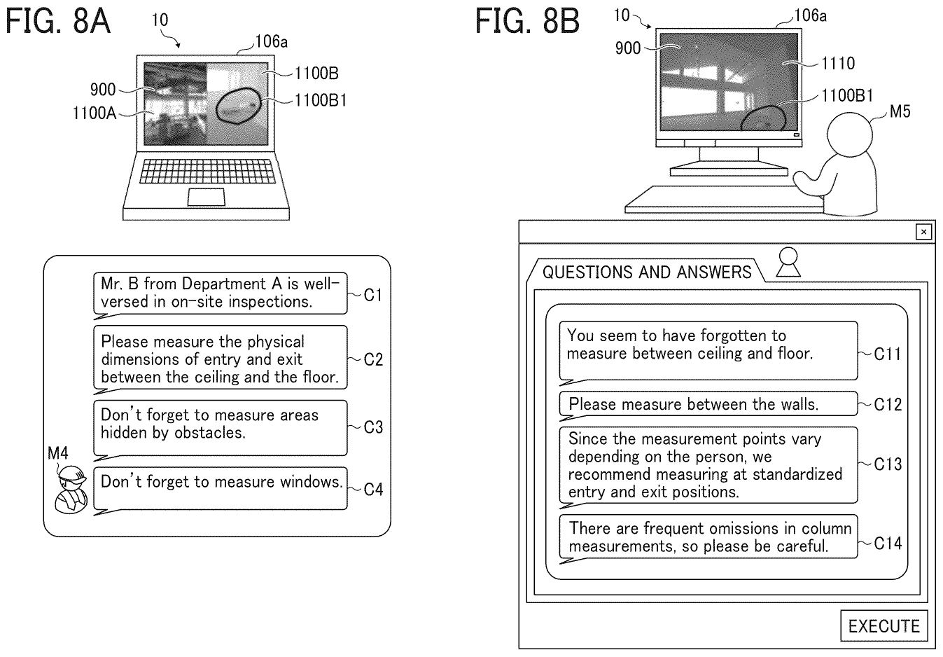

A model update method and a text information generation method are described below with reference to FIGS. 7A to 8B. In FIGS. 7A to 8B, the audio transcript is not used for updating the model and generating the text information. However, learning can be similarly performed by replacing or adding an utterance such as an utterance Q1 in a conversation with the audio transcript.

FIGS. 7A and 7B are diagrams illustrating display screens on the terminal device 10 in a model update process and a text information generation process, respectively. FIG. 7A is a diagram illustrating the model update process. The display control unit 13 of the terminal device 10 causes the display 106a to display a display screen 900 received from the three-dimensional image management server 40. The display screen 900 includes a target image 1100 and text 1200.

The input reception unit 12 of the terminal device 10 receives, via the microphone 109b, audio information indicating a conversation including utterances Q1, A1, Q2, and A2 between a data provider M1 and a data provider M2, as input information input by a data provider on the display screen 900. The data providers M1 and M2 preferably have a wealth of practical knowledge including tacit knowledge. The tacit knowledge model 4004 is updated based on such conversations between data providers including the data providers M1 and M2, allowing the user to obtain useful tacit knowledge-based comments.

The identification unit 44 identifies the target image 1100, which is a portion of the display screen 900 excluding the text 1200.

Then, the determination unit 43 determines the relevance level between the caption comment acquired from the caption model 4003 using the target image 1100 and the conversation including the utterances Q1, A1, Q2, and A2.

The update unit 46 updates the tacit knowledge model 4004 with learning data including the target image 1100 and a tacit knowledge-based comment that is a comment determined to have low relevance among the utterances Q1, A1, Q2, and A2. The update unit 46 updates the caption model 4003 with learning data including the target image 1100 and a caption comment that is a comment determined to have high relevance among the utterances Q1, A1, Q2, and A2.

Thus, the tacit knowledge model 4004 learns the correspondence between the target image 1100 and the utterances Q1, A1, Q2, and A2. Features are extracted from the target image 1100 using multiple image feature extraction models suitable for images, such as a convolutional neural network (CNN). The features represent, for example, which objects (items) appear in which positions and the tasks being performed in an image. Thus, the tacit knowledge model 4004 learns the correspondence between the features of the image and the utterances Q1, A1, Q2, and A2.

FIG. 7B is a diagram illustrating the text information generation process.

The display control unit 13 of the terminal device 10 causes the display 106a to display the display screen 900 received from the three-dimensional image management server 40. The display screen 900 includes an image 1110 and text 1210.

The input reception unit 12 of the terminal device 10 receives, via the microphone 109b, audio information indicating questions Q11 and Q12 asked by a user M3, as input information input by a user on the display screen 900.

The identification unit 44 identifies the image 1110 not including the text 1210 as a target image.

The text information generation unit 45 uses the image 1110 and the tacit knowledge model 4004 to obtain a tacit knowledge-based comment. The tacit knowledge model 4004 extracts features from the image 1110, determines that the features of the image 1110 in FIG. 7B are similar to those of the image 1110 at the time of update, and identifies the utterances Q1, A1, Q2, and A2 related to the image 1110. The utterances Q1, A1, Q2, and A2 are tacit knowledge-based comments.

The text information generation unit 45 generates text information on answers A11 and A12 to the questions Q11 and Q12, respectively, based on the large-scale language model 4005, using, for example, the tacit knowledge-based comments (the utterances Q1, A1, Q2, and A2) and the questions Q11 and Q12.

The display control unit 13 of the terminal device 10 causes the display 106a to display the text information on the answers A11 and A12 received from the three-dimensional image management server 40.

FIGS. 8A and 8B are diagrams illustrating display screens on the terminal device 10 in a model update process and a text information generation process, respectively. Model update without using a question sentence and text information generation without using a question senesce are described below with reference to FIG. 8A and FIG. 8B, respectively.

FIG. 8A is a diagram illustrating the model update process. FIG. 8A illustrates an example in which the tacit knowledge model 4004 is updated by not a conversation between data providers but audio information representing utterances of a single data provider and a partial image.

The display control unit 13 of the terminal device 10 causes the display 106a to display the display screen 900 received from the three-dimensional image management server 40. The display screen 900 includes an image 1100A and an image 1100B.

The input reception unit 12 of the terminal device 10 receives, via the keyboard 110a, character information indicating comments C1 to C4 by a data provider M4, as input information input by a data provider on the display screen 900.

The input reception unit 12 receives, via the mouse 110b, operation information indicating an operation performed by the data provider M4 to identify a partial image 1100B1 of the image 1100B, as input information input by the data provider M4 on the display screen 900.

The identification unit 44 may identify the partial image 1100B1 as a target image. Alternatively, the identification unit 44 may identify the image 1100A or the image 1100B as a target image.

The determination unit 43 determines the relevance between a caption comment acquired from the caption model 4003 using the target image and the comments C1 to C4.

The update unit 46 updates the tacit knowledge model 4004 with learning data including the partial image 1100B1 and a tacit knowledge-based comment that is a comment determined to have low relevance among the comments C1 to C4, and updates the caption model 4003 with learning data including the partial image 1100B1 and a caption comment that is a comment determined to have high relevance among the comments C1 to C4.

Thus, the tacit knowledge model 4004 learns the correspondence between the partial image 1100B1 and the comments C1 to C4. Features are extracted from the partial image 1100B1 by some feature extraction models suitable for images, such as a CNN. The features represent, for example, which objects (items) appear in which positions and the tasks being performed. Thus, the tacit knowledge model 4004 learns the correspondence between the features of the image and the comments C1 to C4.

FIG. 8B is a diagram illustrating the text information generation process. The display control unit 13 of the terminal device 10 causes the display 106a to display the display screen 900 received from the three-dimensional image management server 40. The display screen 900 includes an image 1110.

A user M5 does not input information to the display screen 900. The input reception unit 12 does not receive information input by a user to the display screen 900. The identification unit 44 identifies the image 1110, which is the entire display screen 900, as a target image.

When the user M5 performs an operation for specifying the partial image 1100B1 in the display screen 900, the input reception unit 12 receives, via the mouse 110b, operation information indicating the operation for specifying the partial image as input information. In this case, the identification unit 44 identifies the partial image in the display screen 900 as a target image according to the operation information.

The text information generation unit 45 uses the partial image 1100B1 and the tacit knowledge model 4004 to obtain a tacit knowledge-based comment. The tacit knowledge model 4004 determines that the features of a partial image 1110B1 in FIG. 8B are similar to those of the partial image 1110B1 at the time of update, and identifies the comments C1 to C4 related to the partial image 1110B1. The tacit knowledge model 4004 extracts the comments C1 to C4 as tacit knowledge-based comments.

The text information generation unit 45 generates text information on comments C11 to C14 based on the large-scale language model 4005, using, for example, the tacit knowledge-based comments. The text information generation unit 45 may generate text information using a preset fixed question when no question sentence is input, instead of using a method that does not use any question.

The display control unit 13 of the terminal device 10 causes the display 106a to display the text information on the comments C11 to C14 received from the three-dimensional image management server 40.

### Operations or Processes

As an example of a process based on a captured image and three-dimensional image information, a method for displaying both on a single screen is described below. In other words, the tacit knowledge model 4004 is not used.

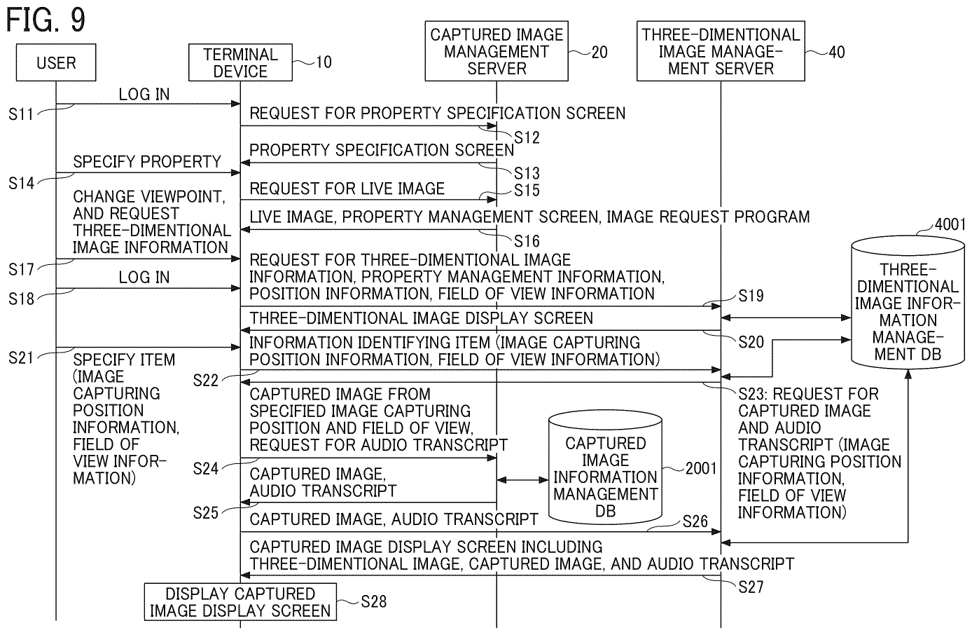

FIG. 9 is a sequence diagram illustrating a process of generating screen information in which a captured image and three-dimensional image information are arranged, as the process based on the captured image and the three-dimensional image information.

In step S11, the user performs a login operation on the terminal device 10. This login is to the captured image management server 20. The input reception unit 12 of the terminal device 10 receives the login operation. The login method may be any existing method. It is assumed that the login is successful.

The user logs in to the captured image management server 20 and then logs in to the three-dimensional image management server 40. Alternatively, the user may log in to the three-dimensional image management server 40 first and then log in to the captured image management server 20.

In step S12, in response to the successful login, the transmission-reception unit 11 of the terminal device 10 transmits a request for a property specification screen 200 to the captured image management server 20.

The transmission-reception unit 21 of the captured image management server 20 receives the request for the property specification screen 200. In step S13, the screen generation unit 22 generates the property specification screen 200, and the transmission-reception unit 21 transmits the screen information of the property specification screen 200 to the terminal device 10.

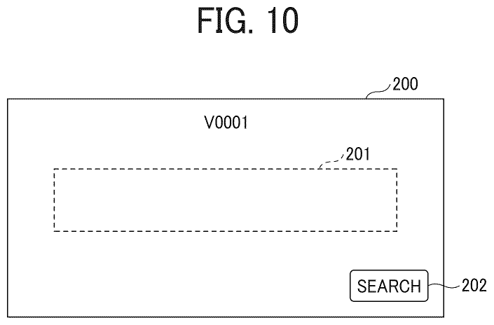

The transmission-reception unit 11 of the terminal device 10 receives the screen information of the property specification screen 200. In step S14, the display control unit 13 causes the property specification screen 200 to be displayed as illustrated in FIG. 10. The user inputs property identification information (for example, V0001 or ABC BUILDING 2F-N) on the property specification screen 200 being displayed. The input reception unit 12 of the terminal device 10 receives the property identification information.

In step S15, the transmission-reception unit 11 of the terminal device 10 specifies the property identification information and transmits a request for a live image to the captured image management server 20.

The transmission-reception unit 21 of the captured image management server 20 receives the request for a live image, and the storing-reading unit 29 searches the captured image information management DB 2001 using the property identification information as a search key. In step S16, the screen generation unit 22 of the captured image management server 20 generates a property management screen 210 displaying a live image, and the transmission-reception unit 21 transmits the screen information of the property management screen 210 to the terminal device 10.

The transmission-reception unit 21 transmits an image request program to the terminal device 10 to allow the terminal device 10 to obtain the live image and three-dimensional image information of the property in response to a request for a live image.

The image request program is, for example, a web application. The web application is installed on the captured image management server 20 by the administrator of the three-dimensional image management server 40, with authorization obtained from the administrator of the captured image management server 20. Alternatively, a Uniform Resource Locator (URL) with the image request program may be transmitted to the terminal device 10. Since the web application is used to acquire three-dimensional image information from the three-dimensional image management server 40, the web application has the function of connecting the terminal device 10 to the three-dimensional image management server 40 and requesting or displaying three-dimensional image information.

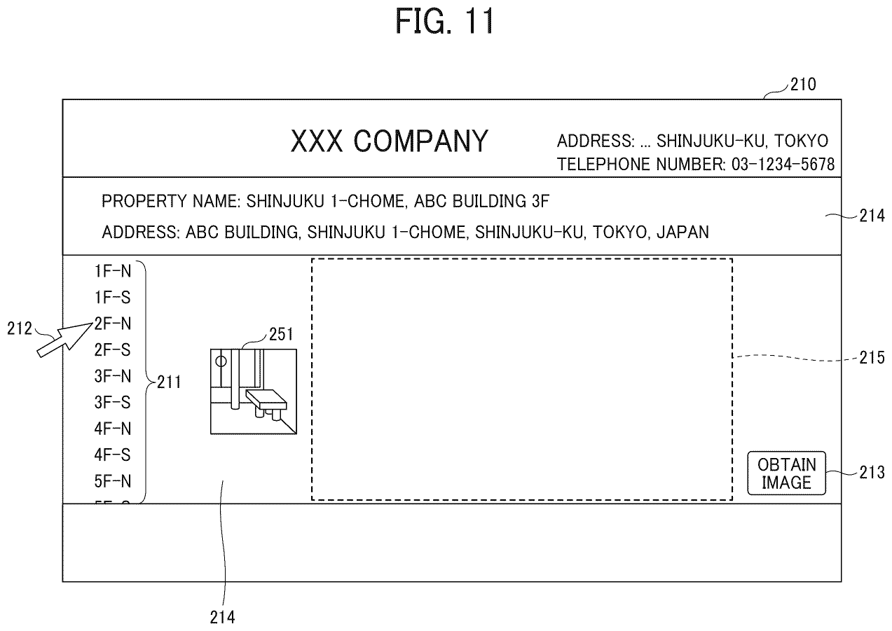

The transmission-reception unit 11 of the terminal device 10 receives the live image, the screen information of the property management screen 210, and the image request program. The display control unit 13 causes the property management screen 210 to be displayed as illustrated in FIG. 11. Thus, the property management information and the live image are displayed. In step S17, a user operation for requesting the three-dimensional image information of the property is performed on the property management screen 210 being displayed. The user operation is, for example, pressing an image acquisition button 213. The viewpoint of the live image can be changed by a user operation. The input reception unit 12 of the terminal device 10 receives the operation for requesting the three-dimensional image information of the property. The three-dimensional image information of the property represents the three-dimensional image information of an item placed in a virtual space representing the property.

The item is represented using 3D model shape information. Since the property has already been specified, the request for the three-dimensional image information of the property may be transmitted to the three-dimensional image management server 40 without the user operation.

The property management screen 210 includes a first display area 214 for displaying the live image acquired from the captured image management server 20 and a second display area 215 for displaying the three-dimensional image information of an item acquired from the three-dimensional image management server 40. In step S7, the property management information and the live image are displayed in the first display area 214, whereas nothing is displayed in the second display area 215.

In step S8, when the user is not logged in to the three-dimensional image management server 40, the user performs a login operation on the terminal device 10. This login operation is to the three-dimensional image management server 40. The input reception unit 12 of the terminal device 10 receives the login operation. The login method may be any existing method. It is assumed that the login is successful. The login operation of the user may be omitted by using, for example, single sign-on.

In step S19, the terminal device 10 executes the image request program to request the three-dimensional image information. Accordingly, the transmission-reception unit 11 specifies the property identification information of the property selected by the user and transmits a request for the three-dimensional image information of the property, the current image capturing position of the image capturing device 5, and the field of view information specified by the user in step S17 to the three-dimensional image management server 40. The current image capturing position of the image capturing device 5 is to be obtained from the captured image management server 20. The transmission-reception unit 11 may transmit the URL of the captured image management server 20 to the three-dimensional image management server 40 so that the terminal device 10 can redirect to the captured image management server 20. The three-dimensional image information of the property is the image of an item placed in the virtual space representing the property. Since the item is represented using the 3D model shape information, the terminal device 10 projects the three-dimensional model shape of the item onto a two-dimensional plane to generate a planar image. The user can browse an item while changing the viewpoint. The transmission-reception unit 11 may transmit the property management information obtained from the captured image management server 20 to the three-dimensional image management server 40. The image request program receives property management information from the web application connected to the captured image management server 20 as, for example, a URL parameter.

In step S20, the transmission-reception unit 41 of the three-dimensional image management server 40 receives the request for the three-dimensional image information of the property, the property management information, the position information, and the field of view information. The storing-reading unit 49 searches the three-dimensional image information management DB 4001 using the property identification information and acquires the three-dimensional image information of each item. The processing unit 47 requests the screen generation unit 42 to generate a screen including the three-dimensional image information of the property. The screen generation unit 42 generates three-dimensional image information by placing a virtual camera at the position of the position information and determining a field of view of the virtual camera based on the field of view information. The screen generation unit 42 generates a screen corresponding to the second display area 215 in which the three-dimensional image information is placed.

The transmission-reception unit 41 transmits the screen information of the screen corresponding to the second display area 215 to the terminal device 10. The three-dimensional image information of each item included in the screen information is three-dimensional image information of each item that is placed in the property, and the user can change the viewpoint as desired. In other words, all items within the property have corresponding three-dimensional image information in the screen information.

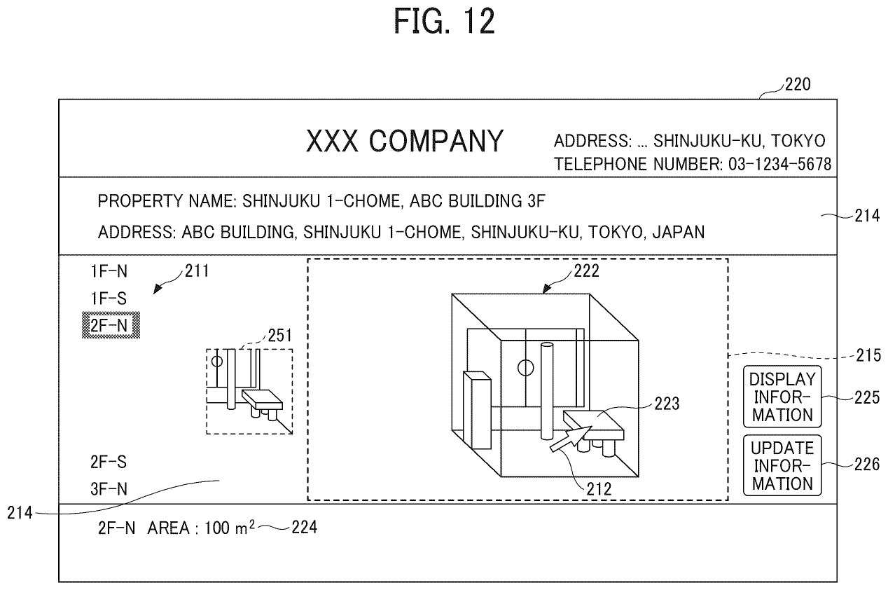

In step S21, the transmission-reception unit 11 of the terminal device 10 receives the screen information of the screen corresponding to the second display area 215, and the display control unit 13 causes a three-dimensional image display screen 220 including the first display area 214 and the second display area 215 to be displayed as illustrated in FIG. 12. In step S21, only the three-dimensional image information of each item is displayed in the second display area 215. In the first display area 214, for example, a live image is displayed. Thus, the live image from the same viewpoint and the three-dimensional image information of the property are displayed on a single screen. Both the live image and the three-dimensional image information allow viewpoint changes.

The user specifies an item from the three-dimensional image information of the property by, for example, pressing the item on the screen. The input reception unit 12 of the terminal device 10 receives an operation for specifying the item. The user can zoom in on any item or change the viewpoint. The user can also specify the field-of-view information. In addition, the terminal device 10 acquires the current image capturing position information of the image capturing device 5 from the captured image management server 20. When the terminal device 10 is fixed, the image capturing position information may be obtained once. When the user specifies the item, the captured image of the item and the audio transcript associated with the captured image can be requested.

The item may be specified by, for example, the coordinates clicked by the user, or the model ID may be specified by the coordinates.

In step S22, when the user presses an information display button 225, the transmission-reception unit 11 of the terminal device 10 transmits information for identifying the item (for example, the model ID), the image capturing position information, and the field-of-view information to the three-dimensional image management server 40.

In step S23, the transmission-reception unit 41 of the three-dimensional image management server 40 receives the information for identifying the item, the image capturing position information, and the field of view information. The transmission-reception unit 41 transmits the image capturing position information and the field of view information to the terminal device 10. The three-dimensional image management server 40 transmits the position information and the field of view information to request the captured image and the audio transcript to the captured image management server 20.

In step S24, the transmission-reception unit 11 of the terminal device 10 receives a request for a captured image and an audio transcript (the image capturing position information and the field of view information). For example, the three-dimensional image management server 40 notifies the terminal device 10 of the URL of the captured image management server 20 and redirects the terminal device 10. Accordingly, the transmission-reception unit 11 of the terminal device 10 specifies the image capturing position information and the field of view information and transmits the request for the captured image and the audio transcript to the captured image management server 20.

In step S25, the transmission-reception unit 21 of the captured image management server 20 receives the request for the captured image and the audio transcript. The storing-reading unit 29 retrieves the captured image and the audio transcript associated with the captured image from the captured image information management DB 2001. The record has position information matching the image capturing position information, and field of view information that is closest to the received field of view information. It is expected that the captured image includes the same item as the three-dimensional image information. The transmission-reception unit 21 transmits the captured image and the audio transcript to the terminal device 10. The captured image management server 20 may capture from the latest live image using the image capturing position information and the field of view information.

In step S26, upon receiving the captured image and the audio transcript, the transmission-reception unit 11 of the terminal device 10 transmits the captured image and the audio transcript to the three-dimensional image management server 40. In step S23, the transmission-reception unit 41 of the three-dimensional image management server 40 receives the captured image and the audio transcript as a response to the request. When the captured image and the audio transcript are received, the storing-reading unit 49 stores the captured image in the three-dimensional image information management DB 4001 in association with the model ID received in step S22. The storing-reading unit 49 may further store the audio transcript.

In step S27, upon receiving the captured image and the audio transcript, the processing unit 47 associates the three-dimensional image information from step S20, the captured image, and the audio transcript, and requests the screen generation unit 42 to generate a screen to display the three-dimensional image information, the captured image, and the audio transcript in association with each other. The screen generation unit 42 generates a screen corresponding to the second display area 215 in which the three-dimensional image information, the captured image, and the audio transcript are displayed in association with each other. The screen generation unit 42 may perform an update process of adding the captured image and the audio transcript to the screen corresponding to the second display area 215 (since the three-dimensional image information has already been). The transmission-reception unit 41 transmits the screen information of the screen corresponding to the second display area 215 to the terminal device 10.

In step S28, the transmission-reception unit 11 of the terminal device 10 receives the screen information of the screen corresponding to the second display area 215, and the display control unit 13 causes a captured image display screen 230 including the first display area 214 and the second display area 215 to be displayed as illustrated in FIG. 13. In step S28, the live image is displayed in the first display area 214, similar to step S21, while the three-dimensional image information of the item, the captured image, and the audio transcript are displayed in the second display area 215.

### Examples of Screens

FIG. 10 is a diagram illustrating the property specification screen 200 for inputting property identification information. The property specification screen 200 includes a property identification information input field 201 and a search button 202. When the user inputs property identification information in the property identification information input field 201 and presses the search button 202, a list of room numbers as illustrated in FIG. 11 is displayed on the property management screen 210.

FIG. 11 is a diagram illustrating the property management screen 210. The property management screen 210 includes the first display area 214 for displaying item-related information acquired from the captured image management server 20 and the second display area 215 for displaying three-dimensional image information of an item acquired from the three-dimensional image management server 40. The first display area 214 is defined as the area of the screen other than the second display area 215. The first display area 214 includes a room number list 211, which is a list of room numbers of the property specified by the property identification information and a live image 251. The live image 251 is represents a video (moving image) stream in real time. Depending on the property, room numbers may not be displayed, and the property specification screen 200 of FIG. 10 may transition to FIG. 12 to display the three-dimensional image information of the property. The user selects, with a mouse cursor 212, a room number whose three-dimensional image information is to be displayed. When the user presses the image acquisition button 213, the three-dimensional image display screen 220 is displayed.

The second display area 215, which is the area of the screen other than the first display area 214, may be displayed by a program, such as iframe, on a web application.

FIG. 12 is a diagram illustrating the three-dimensional image display screen 220. The three-dimensional image display screen 220 includes the first display area 214 and the second display area 215. The live image 251 is displayed in the first display area 214 of the three-dimensional image display screen 220. The live image 251 is represents a video (moving image) stream in real time.

Three-dimensional image information 222 is displayed in the second display area 215 of three-dimensional image display screen 220. In the initial state, the three-dimensional image information 222 with the same image capturing position and the same field of view as the live image 251 is displayed. The image capturing position and the field of view may either be specified by the user for the live image 251 or remain in their initial state. The three-dimensional image information 222 is an image in which the three-dimensional model is projected, allowing users to change the field of view information.

Additionally, the user can select, with a mouse cursor 212, an item whose captured image and audio transcript are to be displayed from the three-dimensional image information 222. With this selecting operation, the coordinates of the item are determined as information for identifying the item. Additionally, since the user zooms in and changes the viewpoint, the field of view of the three-dimensional image information 222 is determined. For example, the user can zoom in and display the table. In addition, the image capturing position of the image capturing device 5 is also acquired. When the user presses the information display button 225, the captured image display screen 230 is displayed. The information display button 225 is used for displaying the captured image and the audio transcript, in addition to displaying the text information generated based on the tacit knowledge-based comment as described later. When the user presses an information update button 226, the tacit knowledge model 4004 is updated.

Since the live image 251 is a wide-field image, the user can change the field of view information. The user may specify the field of view of the live image 251 to identify an item for which a captured image and an audio transcript to be obtained. In this case, the three-dimensional image management server 40 can identify the item selected by the user based on the position and the field of view information of the image capturing device 5. However, in the case of the three-dimensional image information 222, the terminal device 10 can uniquely identify the item based on the coordinates of the mouse pointer on the 3D model.

In FIG. 12, a size (floor area) 224 is displayed as information on the property.

The size (floor area) 224 may be a measured value or may be included in the captured image information management table.

As illustrated in FIG. 12, the terminal device 10 displays the live image 251 managed by the captured image management server 20 and the three-dimensional image information 222 of the property managed by the three-dimensional image management server 40 on a single screen. The user can check the three-dimensional image information 222 of the property while viewing the live image 251. Additionally, the user can change the field of view information to check both.

FIG. 13 is a diagram illustrating the captured image display screen 230. The captured image display screen 230 includes the first display area 214 and the second display area 215. The live image 251 is displayed in the first display area 214.

In FIG. 13, three-dimensional image information 223 of a table selected by the user is displayed in the second display area 215 as an example of an item. The second display area 215 displays a captured image 252. The captured image 252 has a field of view similar to that of the three-dimensional image information 223 of the table. Accordingly, the table as represented in the three-dimensional image information 223 and the table in the captured image 252 are displayed from nearly the same viewpoint. The captured image 252 is obtained from the captured image information management table. When there are multiple captured images with the same field of view in the captured image information management table, the captured image 252 is the latest captured image. Alternatively, the multiple captured images may be displayed in chronological order, starting from the most recent.

An audio transcript 232 corresponding to the captured image is also displayed in the second display area 215. An example of the audio transcript 232 is “This is the initial state.” As described above, the terminal device 10 can display the live image 251, the three-dimensional image information 223, the captured image 252, and the audio transcript 232 associated with the captured image 252 on a single screen.

In some cases, the field of view of the live image 251 in the first display area 214 does not match that of the captured image 252. This occurs when the user specifies an item using the three-dimensional image information 223, as illustrated in FIG. 12. When the user selects an item from the live image 251 in FIG. 12, the field of view of the live image 251 and the field of view of the captured image 252 are the same.

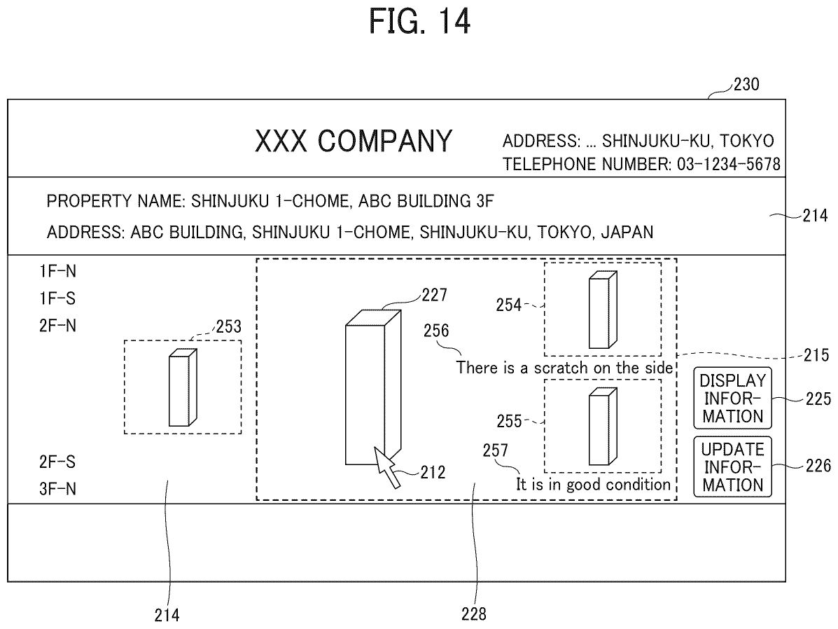

As illustrated in FIG. 14, when the user selects another item using three-dimensional image information, the information displayed in the second display area 215 also correspond to the item. In other words, the display screen content is replaced with content associated with the currently selected item instead of the previously selected item. Specifically, the display control unit 13 switches the captured image display screen 230 of FIG. 13 including the previously selected item to the captured image display screen of FIG. 14 including the currently selected item. FIG. 14 is a diagram illustrating the captured image display screen 230 when the user has selected another item. In FIG. 14, the live image 253 is displayed in the first display area 214. The user zoomed in on the prism within the field of view.

Accordingly, a latest captured image 254 (an example of a second predetermined-area image) and a second most recent captured image 255 (another example of a second predetermined-area image) of the item, which is a prism, are displayed in the second display area 215.

As illustrated in FIG. 14, the terminal device 10 may display the second most recent captured image in the second display area 215. The second display area 215 can display any captured image managed by the captured image management server 20.

The terminal device 10 may have a function linked to the field of view of the live image 253 regarding the three-dimensional image information 227. In other words, when the user manually specifies the field of view for the live image 253, the three-dimensional image information 227 is displayed in real-time at the same field of view. The same applies when the user manually specifies the field of view of the three-dimensional image information 227. As a result, the live image 253, the latest captured image 254, the second most recent captured image 255, and the three-dimensional image information 227 are displayed at the same field of view.

An audio transcript 256 associated with the latest captured image 254 in the image management information table is also displayed. An audio transcript 257 associated with the second most recent captured image 255 in the captured image management information table is also displayed. The second display area 215 may display not only two, but all captured images stored in the captured image management information table.

### Obtaining Captured Images and Audio Transcripts by Image Management Server From Captured Image Management Server

In FIG. 9, the three-dimensional image management server 40 obtains the captured image and comments from the terminal device 10, which were acquired from the captured image management server 20. Alternatively, the three-dimensional image management server 40 may directly obtain the captured image and the audio transcript from the captured image management server 20.

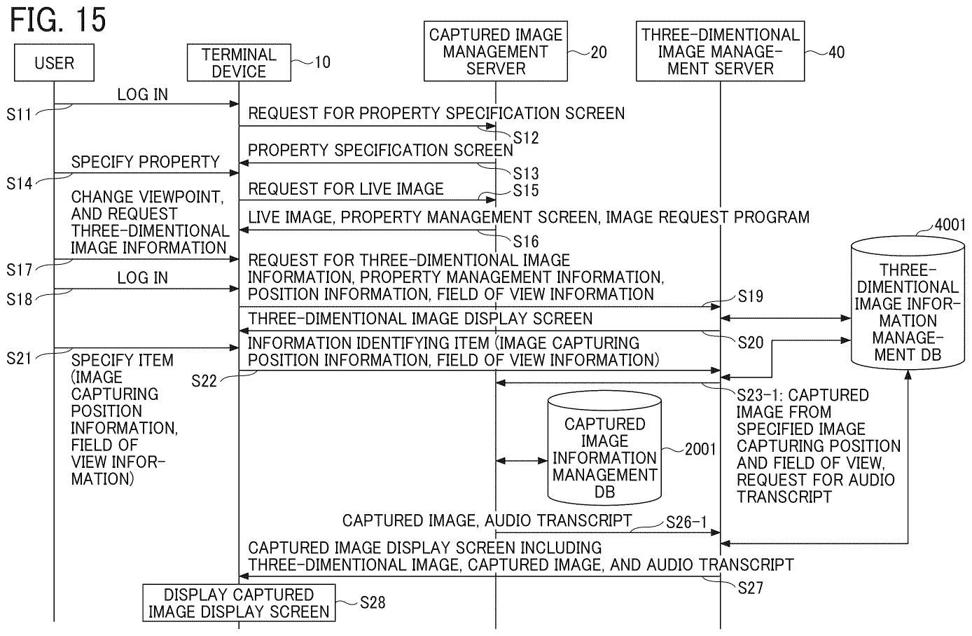

FIG. 15 is a sequence diagram illustrating a process of generating screen information in which a captured image and three-dimensional image information are arranged, as the process based on the captured image and the three-dimensional image information (modification). The following description with reference to FIG. 15 is focused on the differences from FIG. 9. Steps S11 to S22 may be performed similarly to the corresponding steps in FIG. 9.

In step S23, the transmission-reception unit 41 of the three-dimensional image management server 40 receives the information for identifying the item, the image capturing position information, and the field of view information. The transmission-reception unit 41 specifies the image capturing position information and the field of view information and requests a captured image and audio transcript from the captured image management server 20.

The transmission-reception unit 21 of the captured image management server 20 receives the request for the captured image and the audio transcript. The storing-reading unit 29 retrieves the captured image and the audio transcript associated with the captured image from the captured image information management DB 2001. The record has position information matching the image capturing position information, and field of view information that is closest to the received field of view information. The transmission-reception unit 21 transmits the captured image and the audio transcript to the three-dimensional image management server 40. The captured image management server 20 may capture from the latest live image using the image capturing position information and the field of view information.

In step S26-1, the transmission-reception unit 41 of the three-dimensional image management server 40 receives the captured image and the audio transcript as a response to the request.

The subsequent processing may be performed similarly to the corresponding steps illustrated in FIG. 9. In the process as illustrated in FIG. 15, the terminal device 10 can reduce the processing for changing the connection destination, thereby shortening the time required to display the captured image display screen 230.

Since the three-dimensional image management server 40 performs processing based on the captured image and the audio transcript, as well as the three-dimensional image information, the terminal device 10 can display, in the captured image display screen 230, the second display area 215 that including the three-dimensional image information and the captured image and the audio transcript that are associated with the three-dimensional image information. The three-dimensional image management server 40 can performs processing based on the captured image and the audio transcript managed by the captured image management server 20, and the three-dimensional image information managed by the three-dimensional image management server 40, without adding a processing function to the captured image management server 20.

Further, the captured image management server 20 may perform some of the processes based on the captured image and audio transcript managed by the captured image management server 20 and the three-dimensional image information managed by the three-dimensional image management server 40. Even in this case, the process load on the captured image management server 20 is reduced as compared with a case where the captured image management server 20 performs the entire process based on the captured image and the audio transcript managed by the captured image management server 20 and the three-dimensional image information managed by the three-dimensional image management server 40.

The three-dimensional image information, the captured image, and audio transcript may be displayed in an overlapping or non-overlapping manner.

The first display area 214 and the second display area 215 may be displayed in an overlapping or non-overlapping manner.

Further, each of the first display area 214 and the second display area 215 may be divided into multiple sections, and these sections may be displayed in a mixed arrangement.

### Second Embodiment

In a second embodiment described below, the three-dimensional image management server 40 obtains a tacit knowledge-based comment from a tacit knowledge model using three-dimensional image information and a captured image and generates text information based on the tacit knowledge-based comment.

In the present embodiment, the hardware configuration illustrated in FIG. 2 and the functional configuration illustrated in FIG. 3 in the above-described embodiment are applicable.

### Operations or Processes Learning Phase (Model Update)

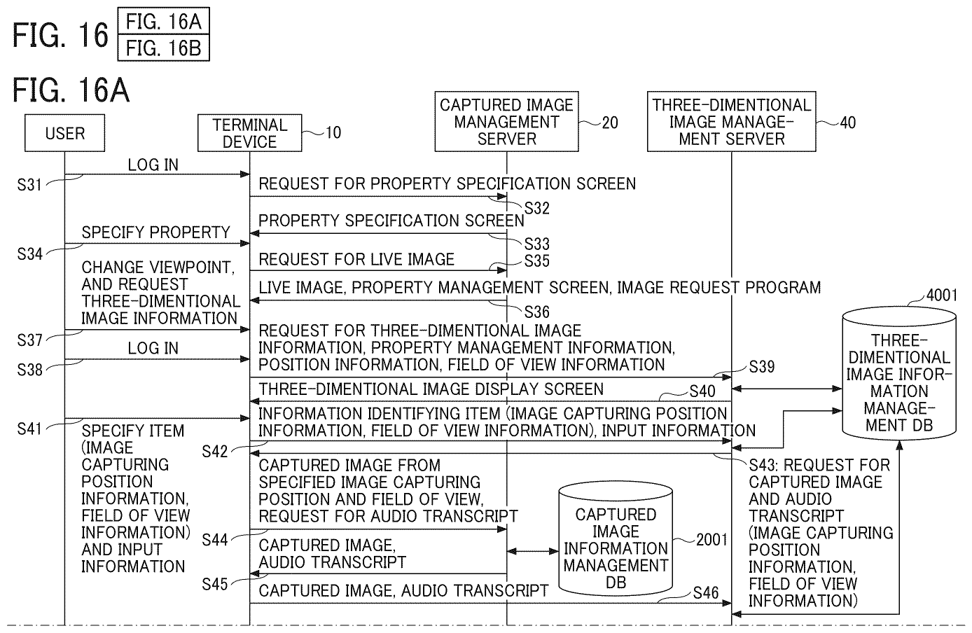

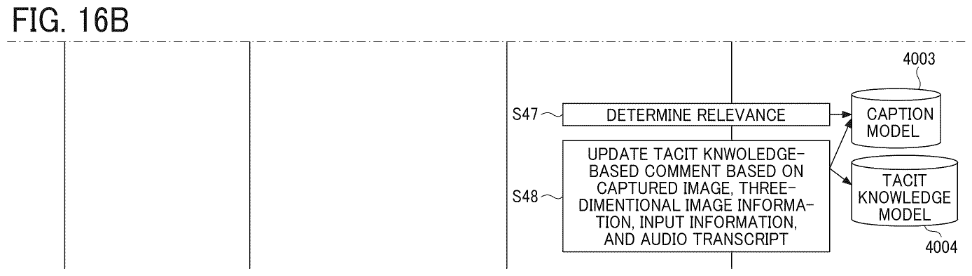

A model update process in which the tacit knowledge model 4004 learns data will be described with reference to FIGS. 16A and 16B (FIG. 16). FIGS. 16A and 16B (FIG. 16) are a sequence diagram illustrating a model update process. The following description with reference to FIGS. 16A and 16B (FIG. 16) focuses on the differences from FIG. 9. Steps S31 to S40 may be performed similarly to the corresponding steps in FIG. 9.

In step S41, in addition to the user operation performed in step S21, the user inputs a comment (character information, audio (voice) information) described with reference to FIGS. 7A and 7B and FIGS. 8A and 8B to the terminal device 10. The comment is related to an item. The comment may be referred to as input information. The input information can be a tacit knowledge-based comment. The input information may also include a caption comment describing the item.

In step S42, when the user presses the information update button 226, the transmission-reception unit 11 of the terminal device 10 transmits information for identifying the item (for example, the model ID), the image capturing position information, the field of view information, and the input information to the three-dimensional image management server 40.

Steps S43 to S46 may be performed similarly to steps S23 to S26 in FIG. 9.

The transmission-reception unit 41 of the three-dimensional image management server 40 receives the captured image and the audio transcript. In step S47, the determination unit 43 obtains the caption comment specified by the model ID (information for identifying the item) from the caption model 4003, and determines the relevance between the caption comment and the comment included in the input information received in step S42. The determination unit 43 may determine the relevance between the obtained caption comment and the entire comment included in the input information received in step S42, or may divide the comment included in the input information received in step S42 into multiple comments and then determine the relevance between the obtained caption comment and each divided comment.

In step S48, the update unit 46 updates the caption model 4003 by associating the input information determined to have a high relevance in step S47 as a caption comment with the model ID. The update unit 46 updates the tacit knowledge model 4004 with learning data including the input information determined to have low relevance in step S47 and the audio transcript, and the three-dimensional image information of the item specified by the field of view information in step S42 and the captured image. In other words, the correspondence between the three-dimensional image information of the item, the captured image, the audio transcript, and the input information is learned. Features are extracted from the three-dimensional image information of the item and the captured image using several feature extraction models suitable for images, such as CNN. The features represent, for example, which objects (items) appear in which positions and the tasks being performed. Thus, the tacit knowledge model 4004 can learn the correspondence between the features of the three-dimensional image information of the item and the captured image, the audio transcript, and the input information.

It is not necessary to use both the audio transcript and the input information, and the tacit knowledge model 4004 can be updated with at least one of the audio transcript and the input information.

In FIGS. 16A and 16B, the three-dimensional image management server 40 obtains the captured image and the audio transcript from the terminal device 10. Alternatively, the three-dimensional image management server 40 may obtain the captured image and the audio transcript from the captured image management server 20 as illustrated in FIG. 15.

### Example of Learning Phase Screen

The screens displayed on the terminal device 10 in the learning phase are similar to those in FIGS. 10 to 12. In FIG. 12, the user can input the input information. The information corresponding to the captured image and the audio transcript displayed in FIG. 13 is displayed in an inference phase described later.

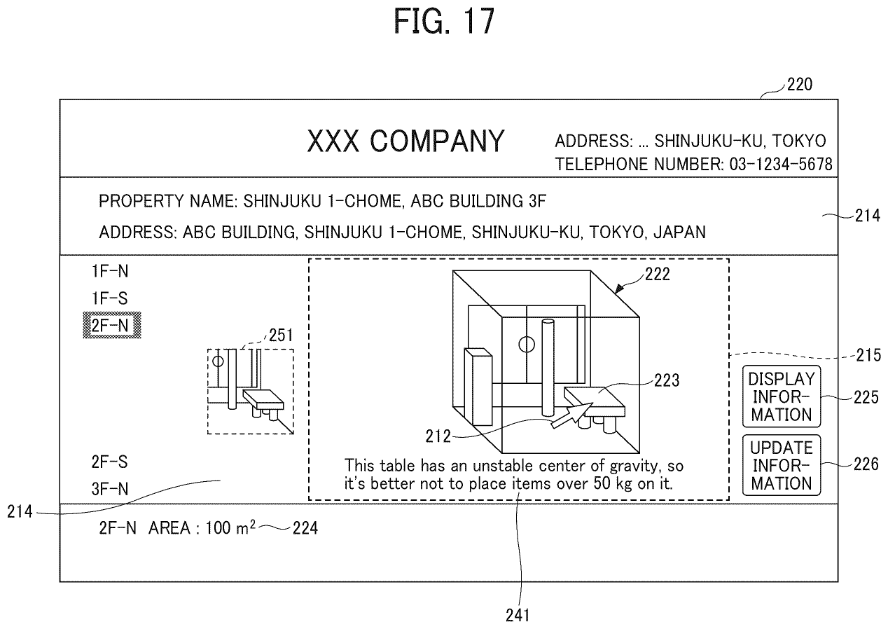

FIG. 17 is a diagram illustrating an example of the three-dimensional image display screen 220 displayed on the terminal device 10. The three-dimensional image display screen 220 in FIG. 17 includes the first display area 214 and the second display area 215. The live image 251 and the size (floor area) 224 indicating the floor area are displayed as information on the property in the first display area 214. In the second display area 215, the three-dimensional image information 222 of the property and the input information 241 entered by the user stating “This table has an unstable center of gravity, so it is better not to place items over 50 kg on it” are displayed. The user inputs the input information 241 while specifying (pressing) the table. The captured image and the audio transcript corresponding to the image capturing position information of the image capturing device 5 and the field-of-view information at the time of the user specifying the table are obtained from the captured image management server 20.

The three-dimensional image management server 40 can update the tacit knowledge model 4004 using such input information 241, the audio transcript associated with the captured image, the three-dimensional image information 223, and the captured image. The size (floor area) 224, which is information on the property, can be a caption comment.

### Inference Phase (Generation of Text Information)

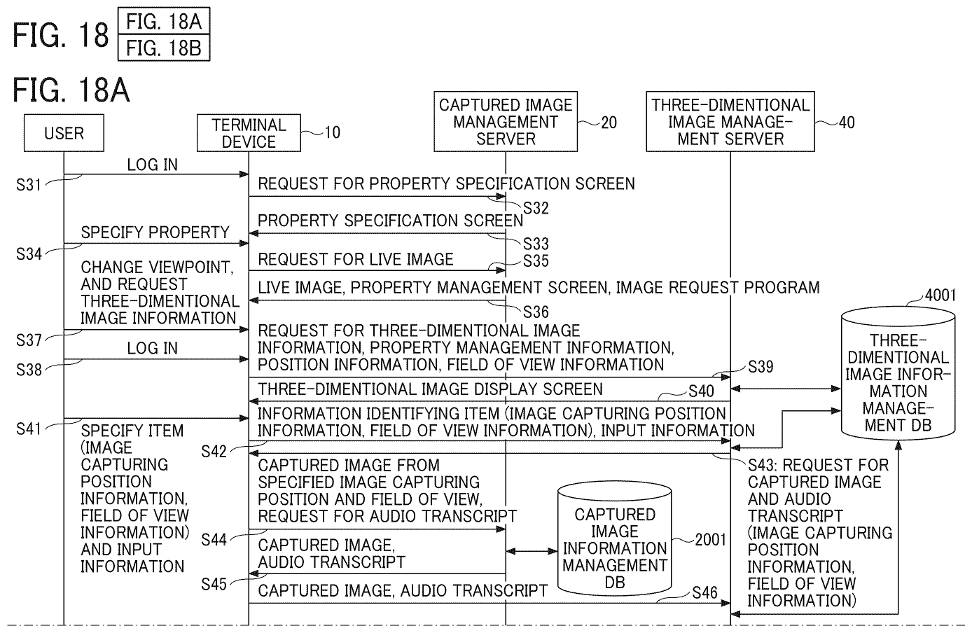

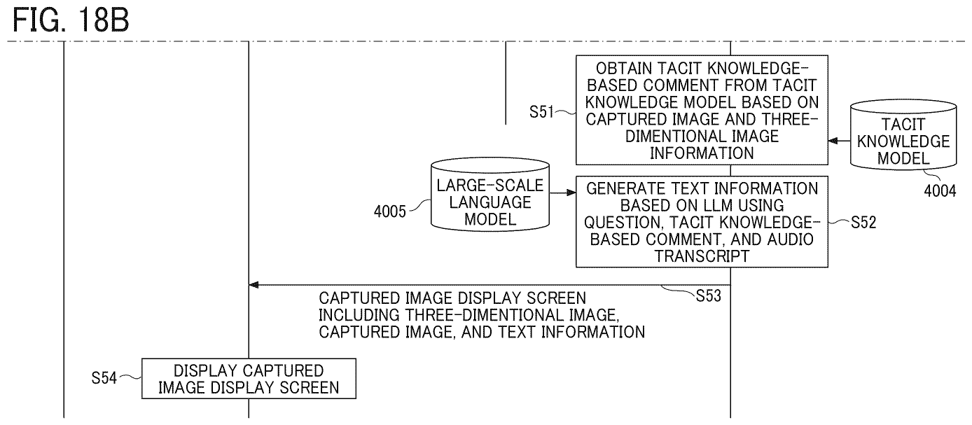

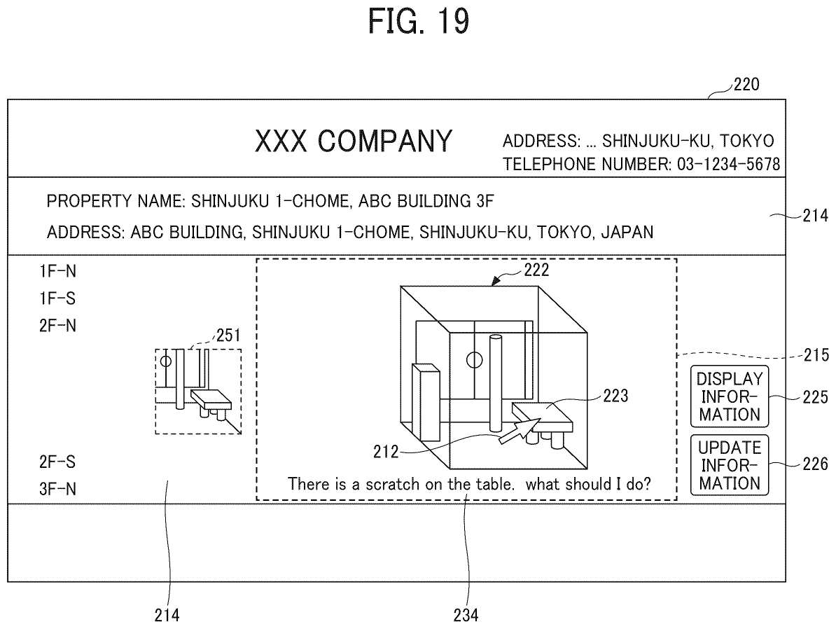

A process of generating text information using the tacit knowledge model 4004 is described below with reference to FIGS. 18A and 18B (FIG. 18). FIGS. 18A and 18B (FIG. 18) are a sequence diagram illustrating the process of generating text information. The following description with reference to FIGS. 18A and 18B (FIG. 18) focuses on the differences from FIG. 9. Steps S31 to S46 may be performed similarly to steps S11 to S26 in FIG. 9. However, in step S41, the user inputs a question sentence related to the item as illustrated in FIG. 19. In addition, the user presses the information display button 225.

In step S51, the transmission-reception unit 41 of the three-dimensional image management server 40 receives the captured image and the audio transcript. The processing unit 47 requests the text information generation unit 45 to generate text information. The text information generation unit 45 obtains a tacit knowledge-based comment corresponding to the three-dimensional image information of the item and the captured image from the tacit knowledge model 4004. The tacit knowledge model 4004 extracts the features of the three-dimensional image information of the item and the captured image and identifies at least one of an audio transcript and input information corresponding to the features. The tacit knowledge model 4004 extracts at least one of such an audio transcript and input information as a tacit knowledge-based comment.

In step S52, the text information generation unit 45 acquires text information generated by the large-scale language model using the tacit knowledge-based comment, the input information (question sentence), and the audio transcript. The large-scale language model 4005 is capable of generating more detailed text information using the tacit knowledge-based comment, the input information (question sentence), and the audio transcript. The text information generation unit 45 may convert audio information included in the input information (question sentence) into character information. The text information generated by the text information generation unit 45 may be either audio information or character information.

The text information generation unit 45 may generate the text information without using any audio transcript or input information. The text information generation unit 45 may generate a fixed question in the system and use the fixed question. In this case, the question sentence is not visible to the user. Alternatively, the text information generation unit 45 may generate one or more fixed questions in the system, cause the fixed questions to be displayed on a display to prompt the user to select one of the fixed questions, and use the selected question.

Although the audio transcript is not essential as described above, generating text information from the large-scale language model 4005 using the audio transcript provides more detailed information on the item. For example, when the audio transcript includes information about the degree of damage of the item, text information including an appropriate handling according to the degree of damage can be generated.

In step S53, the processing unit 47 associates the three-dimensional image information of the item corresponding to the model ID (information for identifying the item), the captured image, and the text information, and requests the screen generation unit 42 to generate a screen to display the three-dimensional image information, the captured image, and the text information in association with each other. The screen generation unit 42 generates a screen corresponding to the second display area 215 that includes the three-dimensional image information and the captured image, and further displays the generated text information.

The screen generation unit 42 may perform an update process of adding only the text information to the screen corresponding to the second display area 215. The transmission-reception unit 41 of the three-dimensional image management server 40 transmits the screen information of the screen corresponding to the second display area 215 to the terminal device 10. The transmission-reception unit 11 of the terminal device 10 receives the screen information of the screen corresponding to the second display area 215 from the three-dimensional image management server 40.

In step S54, the display control unit 13 of the terminal device 10 causes a captured image display screen 230 including the first display area 214 and the second display area 215 to be displayed as illustrated in FIG. 20. The second display area 215 displays the three-dimensional image information, the captured image, and the text information. Alternatively, the conversion unit 15 may convert the received text information into audio information, and the audio control unit 14 may cause the speaker 109a to reproduce the converted text information. When the received text information is audio information, the text information is reproduced by the speaker 109a, or the conversion unit 15 converts the received text information into character information and displays the converted text information on the display 106a.

In FIGS. 18A and 18B (FIG. 18), the three-dimensional image management server 40 obtains the captured image and the audio transcript from the terminal device 10. Alternatively, the three-dimensional image management server 40 may obtain the captured image and the audio transcript from the captured image management server 20 as illustrated in FIG. 15.

Example of Inference Phase Screen The screens displayed on the terminal device 10 in the inference phase are similar to those in FIGS. 10 to 13. In FIG. 12, the user can input a question sentence.

FIG. 19 is a diagram illustrating an example of the three-dimensional image display screen 220 in the inference phase. The three-dimensional image display screen 220 includes the first display area 214 and the second display area 215. FIG. 19 illustrates substantially the same configuration as that of FIG. 12, except that a question sentence is input as input information by the user. The three-dimensional image information 222 of the property is displayed in the second display area 215. Additionally, the user pressed the three-dimensional image information 223 of the table from the three-dimensional image information 222 and input a question sentence as input information (question sentence) 234 specifying the table. For example, the input information (question sentences) 234 in FIG. 19 is a message stating “There is a scratch on the table. What should I do?”. Along with the input information 234, the user presses the information display button 225 to request the generation of text information using the tacit knowledge model.

FIG. 20 is a diagram illustrating text information displayed on the captured image display screen 230. The captured image display screen 230 includes the first display area 214 and the second display area 215. The second display area 215 displays the three-dimensional image information 223 of the table, the captured image 252, and text information 235 related to the three-dimensional image information of the table and the captured image. The text information 235 is a message stating “Since the scratch is less than 1 mm deep, it will be repaired with paint. If it is 1 mm or deeper, it will be polished.” The text information 235 is generated by the large-scale language model 4005 from the three-dimensional image information of the item, the captured image, the audio transcript, and the question sentence. For example, when a scratch on the item is detected from the captured image 252, a tacit knowledge-based comment related to the scratch on the item is extracted. Since the tacit knowledge-based comment, the question related to the scratch, and the audio transcript for determining the current state of the scratch are input to the large-scale language model 4005, text information suitable for the current scratch can be generated.

The text information 235 is not the audio transcript itself but includes at least one of the tacit knowledge-based comment generated by the tacit knowledge model trained to learn the audio transcript, and the text information generated by the large-scale language model 4005 based on the input information, the audio transcript, and the tacit knowledge-based comment. The text information 235 is, in a sense, the result of process based on the audio transcript, the three-dimensional image information, and the captured image.

### Third Embodiment

The three-dimensional image management server 40 that generates an image from a captured image and text information is described below.

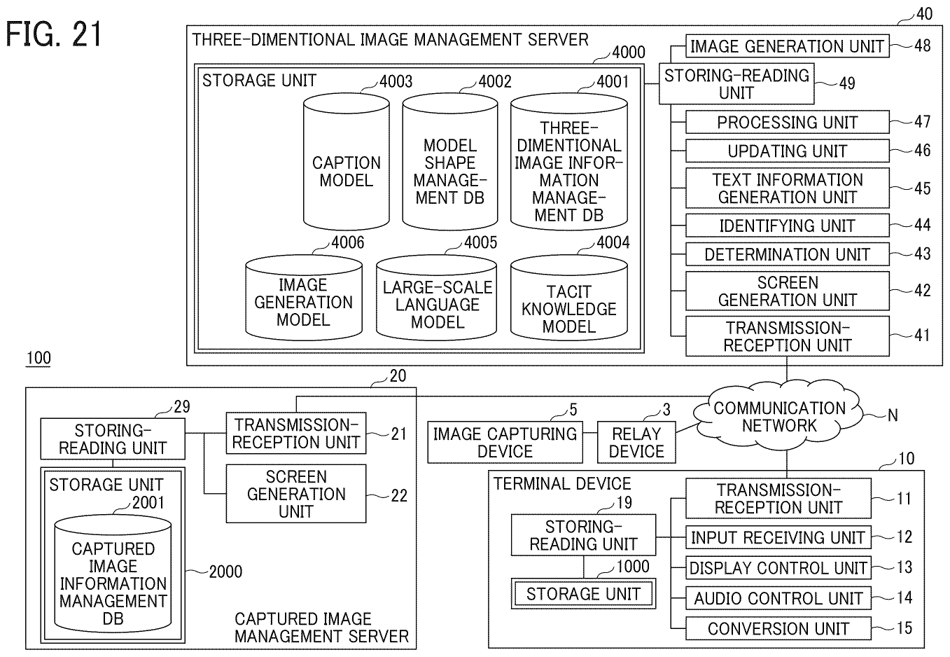

FIG. 21 is a block diagram illustrating functional configurations of the three-dimensional image management server 40, the captured image management server 20, and the terminal device 10 in the information processing system 100. The following description with reference to FIG. 21 focuses on the differences from FIG. 3.

The three-dimensional image management server 40 illustrated in FIG. 21 further includes an image generation unit 48. The storage unit 4000 of the three-dimensional image management server 40 further stores an image generation model 4006. The other configurations may be substantially the same as those illustrated in FIG. 3.

The image generation unit 48, which is an example of an image generation unit, is implemented by instructions from the CPU 401 illustrated in FIG. 2. The image generation unit 51 inputs either text data or both text data into the image generation model 4006 to generate image information.

The image generation model 4006 is a machine learning model (generative AI) that generates images from text data, or from both text data and images. The image generation model 4006 is trained using, for example, learning data including text data and images. The learning data includes, for example, either text data or both text data and an image for learning as an input or inputs, and an image as a correct answer to an output. For example, learning may be performed so that an image generated by the image generation model 4006, into which either the text data or both the text data and an image included in the learning data are input, gets closer to the image as the correct answer included in the learning data.

### Learning Phase

The processing in the learning phase may be substantially the same as that in FIGS. 16A and 16B. In step S48, the update unit 46 updates the tacit knowledge model 4004 such that the tacit knowledge model 4004 learns a correspondence between the comment and audio transcript determined to have low relevance in step S47 and the three-dimensional image information of the item or a two-dimensional image. Alternatively, the update unit 46 updates the tacit knowledge model 4004 such that the tacit knowledge model 4004 learns a correspondence between the comment, audio transcript, and the three-dimensional image information of the item (or a two-dimensional image) and a two-dimensional image (or the three-dimensional image information).

### Inference Phase (Generation of Text Information)

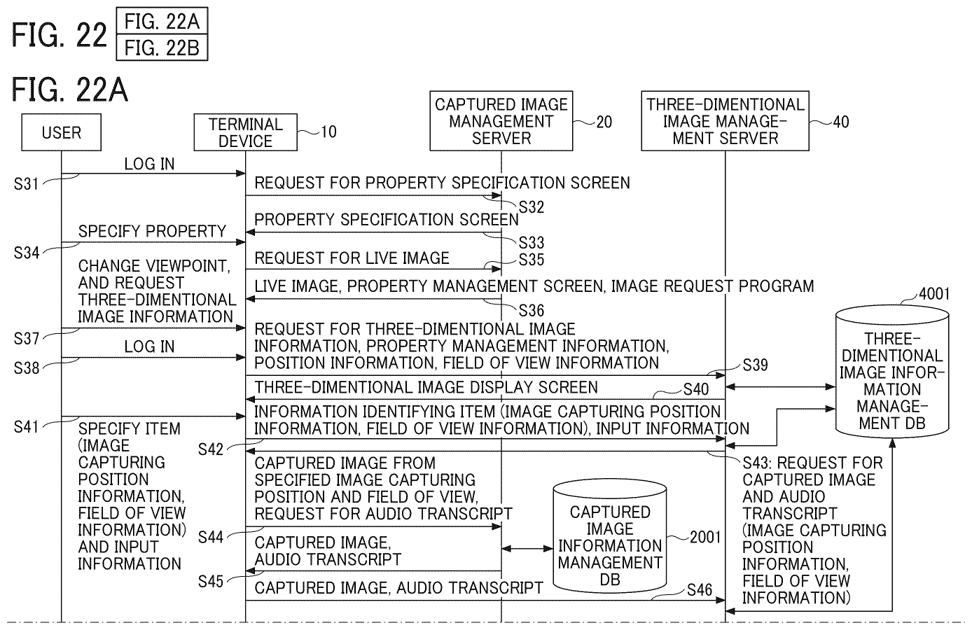

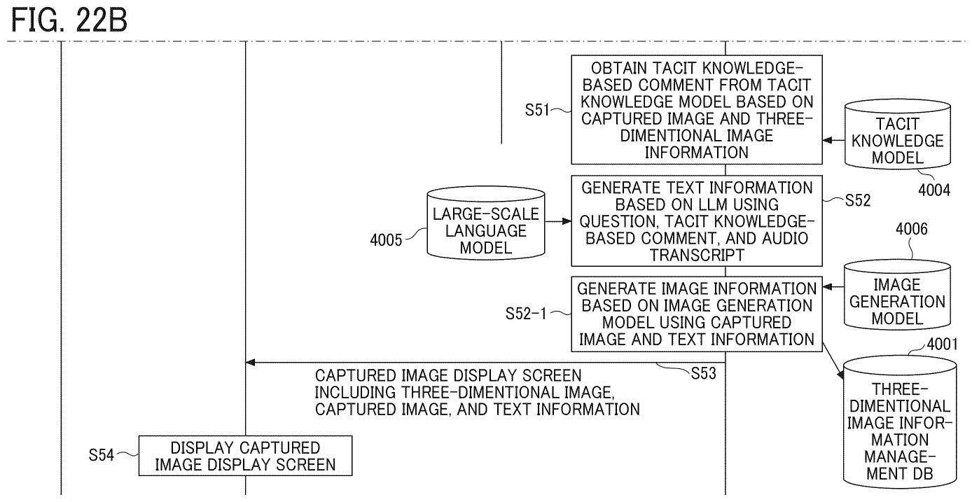

FIGS. 22A and 22B (FIG. 22) are a sequence diagram illustrating a process of generating text information and image information. The following description with reference to FIGS. 22A and 22B (FIG. 22) focuses on the differences from FIGS. 18A and 18B (FIG. 18). In FIGS. 22A and 22B (FIG. 22), step S52-1 is added.

In step S52-1, the image generation unit 48 inputs the captured image and the text information generated by the large-scale language model 4005 to the image generation model 4006 to generate image information. The image generation unit 48 may acquire the image information generated by the image generation model 4006 using the text information generated by the large-scale language model 4005, without using the captured image.

The storing-reading unit 49 stores (or overwrites) the text information generated by the large-scale language model and the image information generated by the image generation model 4006 in the three-dimensional image information management DB 4001 in association with the captured image stored in the image information management DB 4001 in step S46. In step S53, the processing unit 47 associates the three-dimensional image information of the item corresponding to the model identification information, the generated image information, and the text information with each other, and requests the screen generation unit 42 to generate a screen to display the three-dimensional image information of the item, the generated image information, and the text information in association with each other. The screen generation unit 42 generates a screen corresponding to the second display area 215 for displaying the three-dimensional image information of the item, the generated image information, and the text information. The transmission-reception unit 41 of the three-dimensional image management server 40 transmits the screen information of the screen corresponding to the second display area 215 to the terminal device 10. The transmission-reception unit 11 of the terminal device 10 receives the screen information of the screen corresponding to the second display area 215 from the three-dimensional image management server 40.

### Example of Inference Phase Screen

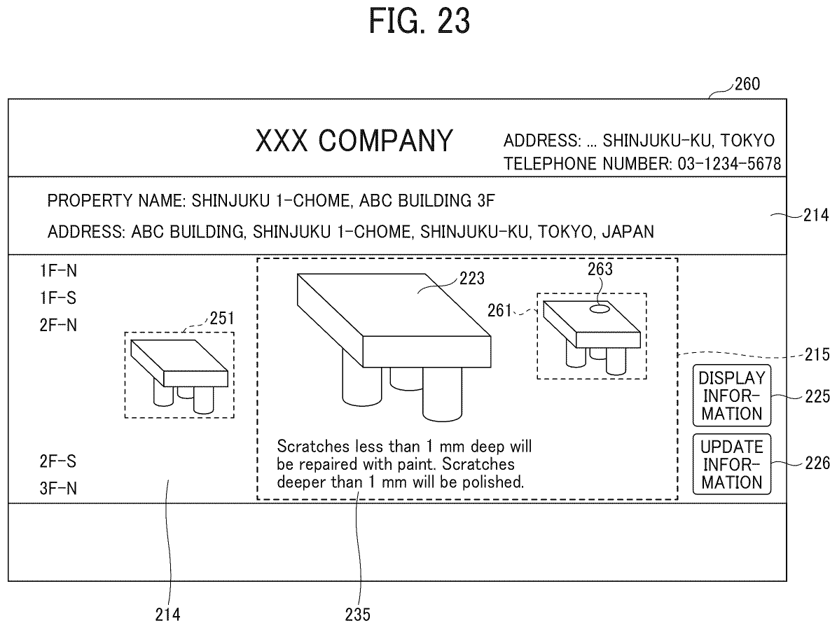

FIG. 23 is a diagram illustrating generated image information displayed on a captured image display screen 260. The following description of FIG. 23 focuses on the differences from FIG. 20.

A generated image 261 is displayed on the captured image display screen 260 of FIG. 23. The generated image 261 is not the captured image 252 described above with reference to FIG. 20. The generated image 261 is generated by the image generation model 4006 based on the captured image 252 and the text information 235. Accordingly, the generated image 261 has a marker 263 indicating the position of the scratch.

Effect of Generating Text Information Using Captured Image An effect of generating text information using captured image, as in the present embodiment, is described below.

### 1. Comparative Example 1 (Case of Using Typical Large-Scale Language Model)

Question sentence: “How can I repair cracks?”
Tacit knowledge-based comment: You can use tape or filler.

### 2. Comparative Example 2 (Case of Learning Three-Dimensional Image Information)

Learning Phase Input image: three-dimensional image information
Comment: Please use tape for wide cracks and filler for narrow cracks.
Inference phase Input image: three-dimensional image display alone
Tacit knowledge-based comment: There are wide and narrow cracks, so it is recommended to use tape for the former and filler for the latter.

### 3. Present Embodiment (Three-Dimensional Image Information and Captured Image, Audio Transcript)

Learning Phase Input image: three-dimensional image information and past captured image
Audio transcript: Applying tape to the corner may cause cracks Inference phase
Input image: three-dimensional image information and captured image
Question sentence: “How can I repair cracks?”
Tacit knowledge-based comment: There are wide and narrow cracks, so it is recommended to use tape for the former and filler for the latter. However, please apply tape carefully to corners, as applying tape to the corner may cause cracks.

Accordingly, “please apply tape carefully to corners, as applying tape to the corner may cause cracks” is an effect of having learned the audio transcript.

### 4. Present Embodiment (Three-Dimensional Image Information and Captured Image, Audio Transcript, Input Information)

Learning Phase Input image: three-dimensional image information and captured image Audio transcript: Applying tape to the corner may cause cracks Input information: Please use tape for wide cracks and filler for narrow cracks.
Inference phase Input image: three-dimensional image display and captured image
Question sentence: “How can I repair cracks?”
Tacit knowledge-based comment: There are wide and narrow cracks, so it is recommended to use tape for the former and filler for the latter. However, please apply tape carefully to corners, as applying tape to the corner may cause cracks.

Accordingly, “please apply tape carefully to corners, as applying tape to the corner may cause cracks” is an effect of having learned the audio transcript.

### Multimodal

Several examples of combinations of input information and tacit knowledge-based comments are described below. Although the above-described model is a large-scale language model, a multimodal model may be used that receives data in multiple data formats, such as images, text, and gestures, and outputs the data in a predetermined data format.

In a case where the input information is string data presented as a text string and the content other than the text information is generated as a tacit knowledge-based comment, the text string is input to generate:
an image;
a moving image; audio; or
a 3D model. In a case where the input information includes string data presented as a text string and non-string data, and the text information is generated as a tacit knowledge-based comment,
an image and the text string are input to generate text information;
a 3D model and the text string are input to generate text information; or
audio and the text string are input to generate text information.

In a case where the input information includes string data presented as a text string and non-string data, and the content other than the text information is generated as a tacit knowledge-based comment,
an image and the text string are input to generate an image;
a moving image and the text string are input to generate a moving image;
a 3D model and the text string are input to generate a 3D model; or
audio and the text string are input to generate audio.

The three-dimensional image management server described above updates the tacit knowledge model with the three-dimensional image information, the captured image, and the audio transcript as the process based on the three-dimensional image information, the captured image, and the audio transcript. This allows the terminal device 10 to display the tacit knowledge-based comment corresponding to the three-dimensional image information, the obtained captured image and the audio transcript. Even when the captured image and the audio transcript are not obtained at the time of generating the text information, the tacit knowledge model can output a tacit knowledge-based comment generated based on the obtained three-dimensional image information, considering the input information.

The above-described embodiments are illustrative and do not limit the present invention. Thus, numerous additional modifications and variations are possible in light of the above teachings without deviating from the scope of the present invention. The three-dimensional image management server 40 described in the present embodiment is merely an example, and various system configuration examples are available according to the application and purpose.

Although examples in which the tacit knowledge models of the industry, such as civil engineering or construction, answer questions have been described, the tacit knowledge models may be used in any industry in which tacit knowledge is effective, such as medical care, dental care, and investment determination.

Although examples in which the large-scale language model 4005 generates text information based on tacit knowledge-based comments have been described, the tacit knowledge-based comments may be used as text information without using the large-scale language model 4005.

The tacit knowledge model 4004 may be trained to learn tacit knowledge-based comments using three-dimensional image information and audio transcript as inputs and using input information as an output. In other words, information in different forms, such as an image and text, may be input to the tacit knowledge model 4004.

Although the information processing system 100 in a client-server configuration has been described, the function of the three-dimensional image management server 40 may be installed as an application on the terminal device 10. In other words, the functions described above may be made available to the user in a stand-alone manner.

In the configuration illustrated in, for example, FIG. 3, the processing by the three-dimensional image management server 40 is divided according to the main functions to facilitate understanding. No limitation to a scope of the present disclosure is intended by how the processes are divided or by the name of the processes. The processing performed by the three-dimensional image management server 40 may be divided into a greater number of processing units depending on the processing details. Further, a single processing unit can be further divided into multiple processing units.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The group of apparatuses or devices described above is one example of plural computing environments that implement the embodiments disclosed in this specification. In some embodiments, the three-dimensional image management server 40 includes multiple computing devices, such as a server cluster. The computing devices are configured to communicate with each other via any type of communication link, including a network, shared memory, etc., and perform the processes disclosed in the above-described embodiment.

Further, the three-dimensional image management server 40 may variously combine the disclosed processing steps. The components of the three-dimensional image management server 40 may be combined into a single apparatus or may be divided into a plurality of apparatuses. Further, one or more processes performed by the three-dimensional image management server 40 may be performed by the terminal device 10.

### Aspect 1

An information processing system includes a first server to store and manage a wide-field image obtained via an image capturing device capturing an image of a target object and a predetermined-area image in the wide-field image, a second server to store and manage three-dimensional image information of the target object, and a terminal device to communicate with the first server and the second server.

The terminal device includes a display control unit to display a display screen including the wide-field image received from the first server and the three-dimensional image information received from the second server.

The second server includes a processing unit to perform processing for associating, based on the predetermined-area image received from the first server and the three-dimensional image information, the three-dimensional image information with the predetermined-area image or the three-dimensional image information with generated information that is generated based on the three-dimensional image information and the predetermined-area image.

The display control unit of the terminal device displays, on the display screen, the predetermined-area image corresponding to the three-dimensional image information or the generated information corresponding to the three-dimensional image information along with the three-dimensional image information. The three-dimensional image information, and the predetermined-area image associated with (corresponding to) the three-dimensional image information or the generated information associated with (corresponding to) the three-dimensional image information are received from the second server.

### Aspect 2

In the information processing system according to Aspect 1, the display control unit of the terminal device displays the display screen including a first display area for displaying the wide-field image received from the first server, and a second display area for displaying the three-dimensional image information, and the predetermined-area image associated with (corresponding to) the three-dimensional image information or the generated information associated with (corresponding to) the three-dimensional image information that are received from the second server.

### Aspect 3

In the information processing system according to Aspect 1 or Aspect 2, the second server stores in a storage unit the predetermined-area image received from the first server in association with the three-dimensional image information associated with identification information of the target object specified at the terminal device.

### Aspect 4

In the information processing system of Aspect 1, the processing unit requests the first server to transmit the predetermined-area image, and receives the predetermined-area image from the first server as a response to the request.

### Aspect 5

In the information processing system of any one of Aspects 1 to 5, the second server obtains the predetermined-area image transmitted from the first server and comment data associated with the predetermined-area image, and includes a model trained to learn a correspondence between the three-dimensional image information of the target object, the predetermined-area image, and the comment data.

The processing unit obtains the generated information being text information generated by the model, based on the three-dimensional image information of the target object and the predetermined-area image. A selection of the target object is received by the terminal device.

### Aspect 6

In the information processing system of Aspect 5, the second server includes another model trained to learn a correspondence between the three-dimensional image information of the target object, the predetermined-area image, the comment data, and input information received from the terminal device.

The processing unit obtains the generated information being text information generated by the other model, based on the three-dimensional image information of the target object and the predetermined-area image. A selection of the target object is received by the terminal device.

### Aspect 7

In the information processing system of Aspect 5, the second server includes an update unit to update the model by causing the model to learn the correspondence between the three-dimensional image information of the target object, the predetermined-area image, and the comment data.

### Aspect 8

In the information processing system of Aspect 6, the second server includes an update unit to update the other model by causing the other model to learn the correspondence between the three-dimensional image information of the target object, the predetermined-area image, the comment data, and the input information received from the terminal device.

### Aspect 9

In the information processing system of Aspect 1, the terminal device includes an input reception unit to receive a selection of another target object other than the target object while the display control unit displays, on the display, the three-dimensional image information received from the second server, and the predetermined-area image associated with (corresponding to) the three-dimensional image information or the generated information associated with (corresponding to) the three-dimensional image information received from the second server.

The processing unit performs processing for associating, based on a second predetermined-area image related to the other target object received from the first server and additional three-dimensional image information of the other target object, the additional three-dimensional image information of the other target object and the second predetermined-area image, or performs processing for associating, based on the second predetermined-area image related to the other target object received from the first server and the additional three-dimensional image information of the other target object, the additional three-dimensional image information of the other target object with additional generated information generated based on the additional three-dimensional image information of the other target object and the second predetermined-area image.

The display control unit of the terminal device displays, on the display screen, the additional three-dimensional image information of the other target object and the one of the second predetermined-area image and the additional generated information associated with (corresponding to) the additional three-dimensional image information of the other target object by replacing the three-dimensional image information of the target object and the one of the predetermined-area image and the generated information associated with the three-dimensional image information. The additional three-dimensional image information of the other target object and the one of the second predetermined-area image and the additional generated information associated with (corresponding to) the additional three-dimensional image information of the other target object are received form the second server.

According to one aspect of the present disclosure, the process based on information managed by the first server and information managed by the second server can be performed without adding a processing function to the first server.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing system, comprising:
a first server to manage a first image obtained from an image capturing device capturing an image of a target object and a second image of the first image, the first server including first server circuitry;
a second server to manage three-dimensional image information of the target object, the second server including second server circuitry; and
a terminal device to communicate with the first server and the second server, the terminal device including terminal device circuitry configured to display, on a display screen, the first image received from the first server and the three-dimensional image information received from the second server, wherein
the second server circuitry is configured to associate, based on the second image received from the first server and the three-dimensional image information, the three-dimensional image information with one of the second image and generated information, the generated information being generated based on the three-dimensional image information and the second image, and
the terminal device circuitry is further configured to display, on the display screen, the three-dimensional image information and the one of the second image and the generated information in association with each other, the three-dimensional image information and the one of the second image and the generated information being received from the second server.

2. The information processing system of claim 1, wherein
the display screen includes a first display area for displaying the first image received from the first server and a second display area for displaying the three-dimensional image information and the one of the second image and the generated information that are received form the second server.

3. The information processing system of claim 1, wherein
the second server circuitry is further configured to store, in a memory, the second image received from the first server in association with the three-dimensional image information associated with identification information of the target object identified at the terminal device.

4. The information processing system of claim 1, wherein
the second server circuitry is further configured to:
request the second image from the first server; and
obtain the second image from the first server.

5. The information processing system of claim 1, wherein
the second server further comprising a memory that stores a model trained to learn a correspondence between the three-dimensional image information of the target object, the second image, and comment data,
the second server circuitry is further configured to:
obtain the second image received from the first server and the comment data associated with the second image; and
obtain the generated information, the generated information being text information generated by the model based on the three-dimensional image information of the target object selected at the terminal device and the second image.

6. The information processing system of claim 5, wherein
the memory stores another model trained to learn a correspondence between the three-dimensional image information of the target object, the second image, the comment data, and input information received from the terminal device, and
the second server circuitry is further configured to obtain another generated information, said another generated information being additional text information generated by said another model based on the three-dimensional image information of the target object selected at the terminal device and the second image.

7. The information processing system of claim 5, wherein
the second server circuitry is further configured to cause the model to learn the correspondence between the three-dimensional image information of the target object, the second image, and the comment data to update the model.

8. The information processing system of claim 6, wherein
the second server circuitry is further configured to cause said another model to learn the correspondence between the three-dimensional image information of the target object, the second image, the comment data, and the input information to update said another model.

9. The information processing system of claim 1, wherein
the terminal device circuitry is further configured to receive a selection of another target object other than the target object while displaying, on the display screen, the three-dimensional image information of the target object and the one of the second image and the generated information that are received from the second server,
the second server circuitry is further configured to associate, based on another second image related to said another target object and additional three-dimensional image information of said another target object, the additional three-dimensional image information with one of said another second image and additional generated information, said another second image being received from the first server, said additional generated information being generated based on the additional three-dimensional image information and said another second image, and
the terminal device circuitry is further configured to display, on the display screen, the additional three-dimensional image information and the one of said another second image and the additional generated information being received from the second server.

10. A server, comprising circuitry configured to:
associate, based on a second image received from another server and three-dimensional image information of a target object, the three-dimensional image information with one of the second image and generated information, the generated information being generated based on the three-dimensional image information and the second image, said another server managing a first image obtained from an image capturing device capturing an image of the target object and the second image that is an image of a second in the first image; and
transmit, to a terminal device, the three-dimensional image information and the one of the second image and the generated information, the three-dimensional image information and the one of the second image and the generated information being to be displayed in association with each other on a display screen of the terminal device.

11. An information processing method performed by a server, the method comprising:
associating, based on a second image received from another server and three-dimensional image information of a target object, the three-dimensional image information with one of the second image and generated information, the generated information being generated based on the three-dimensional image information and the second image, said another server managing a first image obtained from an image capturing device capturing an image of the target object and the second image that is an image of a second in the first image; and
transmitting, to a terminal device, the three-dimensional image information and the one of the second image and the generated information, the three-dimensional image information and the one of the second image and the generated information being to be displayed in association with each other on a display screen of the terminal device.

12. A non-transitory recording medium storing a plurality of instructions which, when executed by one or more processors, causes the one or more processors to perform a method, the method comprising:
associating, based on a second image received from another server and three-dimensional image information of a target object, the three-dimensional image information with one of the second image and generated information, the generated information being generated based on the three-dimensional image information and the second image, said another server managing a first image obtained from an image capturing device capturing an image of the target object and the second image that is an image of a second in the first image; and
transmitting, to a terminal device, the three-dimensional image information and the one of the second image and the generated information, the three-dimensional image information and the one of the second image and the generated information being to be displayed in association with each other on a display screen of the terminal device.
